(19) United States
(12) Patent Application Publication
(10) Pub. No.: US 2007/0227579 A1
(43) Pub. Date: Oct. 4, 2007

(54) Assemblies of cylindrical solar units with internal spacing

(76) Inventors: Benyamin Buller, Cupertino, CA (US); Chris M. Gronet, Portola Valley, CA (US); James K. Truman, High Springs, FL (US)

Correspondence Address: JONES DAY, 222 EAST 41ST ST, NEW YORK, NY, 10017, US

(21) Appl. No.: 11/396,069

(22) Filed: Mar. 30, 2006

(51) Int. Cl. H02N 6/00

(52) U.S. Cl. 136/244

(57) ABSTRACT

A solar cell arrangement comprising a solar cell assembly having cylindrical solar units arranged parallel or approximately parallel to each other in a common plane. A first and a second cylindrical solar unit in the plurality of solar cell units are separated from each other by a spacer distance thereby allowing direct sunlight to pass between the cylindrical solar units. Each cylindrical solar unit in the plurality of solar units is at least a separation distance away from an installation surface.

### 1. FIELD OF THE INVENTION

This invention relates to arrangements of solar units. More specifically, this invention relates to systems and methods for spatially arranging cylindrical solar units within a solar cell panel or solar cell array to optimize conversion of solar energy into electrical energy. Solar units are either solar cells or monolithically or non-monolithically integrated solar modules.

### 2. BACKGROUND OF THE INVENTION

A problem confronting utility companies today is the great variance in total energy demand on a network between peak and off-peak times during the day. This is particularly the case in the electrical utility industry. The so-called peak demand periods or load shedding intervals are periods of very high demand on the power generating equipment where load shedding can be necessary to maintain proper service to the network. These occur, for example, during hot summer days occasioned by the widespread simultaneous usage of electric air conditioning devices. Typically the load shedding interval may last many hours and normally occurs during the hottest part of the day such as between the hours of noon and 6:00 PM. Peaks can also occur during the coldest winter months in areas where the usage of electrical heating equipment is prevalent. In fact, power requirements can vary not only due to variations in the energy needs of energy consumers that are attempting to accomplish intended goals, but also due to environmental regulations and market forces pertaining to the price of electrical energy. In the past, in order to accommodate the very high peak demands, the industry has been forced to spend tremendous amounts of money either in investing in additional power generating capacity and equipment or in buying so-called “peak” power from other utilities which have made such investments.

To meet fluctuating energy demands, energy producers can either individually adjust the energy that they are producing and outputting and/or operate in cooperation with one another to collectively adjust their output energy. One way to alleviate the demands on a utility company infrastructure is to use alternative electrical generating sources such as solar cells. The capacity of solar cells in generating electricity, however, is limited to the time period when they are exposed to solar radiation. Existing solar cell systems in the art reach peak capacity around noon when incoming solar radiation has relatively small angles of incidence. In general, the peak solar cell system efficiency occurs before peak electrical demand. As illustrated in FIGS. 1B and 1C, peak electricity demand changes during the hours of the day with respect to geographical locations and seasonal changes. For example, as illustrated in FIG. 1C, electricity demand peaks during early evening hours around 6 PM and 7 PM in California in December of one year. In Ontario Canada on Mar. 28, 2006, electricity demand peaked almost twice, once around 9 μM and again around 9 PM. FIG. 1B shows a large scale change in electricity demand in California in 1998. Overall, electricity demand in 1998 in California peaked around 4 PM. FIG. 1B further illustrates that the shift of the peak hour into early evening hours is largely due to residential use of electricity. Accordingly, power grid managers such Independent Electricity System Operator (IESO) and Alberta Electricity System Operator (AESO) have developed sophisticated systems to track power demand and usage as a function of time. Additional information on power grid requirements as a function of time is available from Independent Electricity System Operator (IESO), the web site hosted by the Alberta Electricity System Operator (AESO), as well as AC Propulsion Inc.

Solar cells are typically fabricated as separate physical entities with light gathering surface areas on the order of 4-6 cm² or larger. For this reason, it is standard practice for power generating applications to mount the cells in a flat array on a supporting substrate or panel so that their light gathering surfaces provide an approximation of a single large light gathering surface. Also, since each solar cell itself generates only a small amount of power, the required voltage and/or current is realized by interconnecting the cells of the array in a series and/or parallel matrix.

A conventional prior art solar cell structure is shown in FIG. 1A. Because of the large range in the thickness of the different layers, they are depicted schematically. Moreover, FIG. 1 is highly schematic so that it represents the features of both “thick-film” solar cells and “thin-film” solar cells. In general, solar cells that use an indirect band gap material to absorb light are typically configured as “thick-film” solar cells because a thick film of the absorber layer is required to absorb a sufficient amount of light. Solar cells that use a direct band gap material to absorb light are typically configured as “thin-film” solar cells because only a thin layer of the direct band-gap material is needed to absorb a sufficient amount of light.

The arrows at the top of FIG. 1A show the source of direct solar illumination on the cell. Layer 102 is the substrate. Glass or metal is a common substrate. In thin-film solar cells, substrate 102 can be-a polymer-based backing, metal, or glass. In some instances, there is an encapsulation layer (not shown) coating substrate 102. Layer 104 is the back electrical contact for the solar cell.

Layer 106 is the semiconductor absorber layer. Back electrical contact 104 makes ohmic contact with absorber layer 106. In many but not all cases, absorber layer 106 is a p-type semiconductor. Absorber layer 106 is thick enough to absorb light. Layer 108 is the semiconductor junction partner that, together with semiconductor absorber layer 106, completes the formation of a p-n junction. A p-n junction is a common type of junction found in solar cells. In p-n junction based solar cells, when semiconductor absorber layer 106 is a p-type doped material, junction partner 108 is an n-type doped material. Conversely, when semiconductor absorber layer 106 is an n-type doped material, junction partner 108 is a p-type doped material. Generally, junction partner 108 is much thinner than absorber layer 106. For example, in some instances junction partner 108 has a thickness of about 0.05 microns. Junction partner 108 is highly transparent to solar radiation. Junction partner 108 is also known as the window layer, since it lets the light pass down to absorber layer 106.

In a typical thick-film solar cell, absorber layer 106 and window layer 108 can be made from the same semiconductor material but have different carrier types (dopants) and/or carrier concentrations in order to give the two layers their distinct p-type and n-type properties. In thin-film solar cells in which copper-indium-gallium-diselenide (CIGS) is the absorber layer 106, the use of CdS to form junction partner 108 has resulted in high efficiency cells. Other materials that can be used for junction partner 108 include, but are not limited to, SnO₂, ZnO, ZrO₂, and doped ZnO.

Layer 110 is the counter electrode, which completes the functioning solar cell. Counter electrode 110 is used to draw current away from the junction since junction partner 108 is generally too resistive to serve this function. As such, counter electrode 110 should be highly conductive and transparent to light. Counter electrode 110 can in fact be a comb-like structure of metal printed onto layer 108 rather than forming a discrete layer. Counter electrode 110 is typically a transparent conductive oxide (TCO) such as doped zinc oxide (e.g., aluminum doped zinc oxide), indium-tin-oxide (ITO), tin oxide (SnO₂), or indium-zinc oxide. However, even when a TCO layer is present, a bus bar network 114 is typically needed in conventional solar cells to draw off current since the TCO has too much resistance to efficiently perform this function in larger solar cells. Network 114 shortens the distance charge carriers must move in the TCO layer in order to reach the metal contact, thereby reducing resistive losses. The metal bus bars, also termed grid lines, can be made of any reasonably conductive metal such as, for example, silver, steel or aluminum. In the design of network 114, there is design a trade off between thicker grid lines that are more electrically conductive but block more light, and thin grid lines that are less electrically conductive but block less light. The metal bars are preferably configured in a comb-like arrangement to permit light rays through layer 110. Bus bar network layer 114 and layer 110, combined, act as a single metallurgical unit, functionally interfacing with a first ohmic contact to form a current collection circuit. In U.S. Pat. No. 6,548,751 to Sverdrup et al., hereby incorporated by reference herein in its entirety, a combined silver bus bar network and indium-tin-oxide layer function as a single, transparent ITO/Ag layer.

Layer 112 is an antireflective coating that can allow a significant amount of extra light into the cell. Depending on the intended use of the solar cell, it might be deposited directly on the top conductor as illustrated in FIG. 1A. Alternatively or additionally, antireflective coating 112 made be deposited on a separate cover glass that overlays top electrode 110. Ideally, the antireflective coating reduces the reflection of the cell to very near zero over the spectral region in which photoelectric absorption occurs, and at the same time increases the reflection in the other spectral regions to reduce heating. U.S. Pat. No. 6,107,564 to Aguilera et al., hereby incorporated by reference herein in its entirety, describes representative antireflective coatings that are known in the art. In some instances, antireflective coating 112 is made of TiOₓ deposited, for example, by chemical deposition. In some instances, antireflective coating 112 is made of SiNₓ deposited, for example, by plasma enhanced chemical vapor deposition. In some embodiments, there is more than one layer of antireflective coating. For example, double layer coatings with λ/4 design, with growing indices from air to the semiconductor junction layer can be employed. One such design uses evaporated SZn and MgF₂.

Solar cells typically produce only a small voltage. For example, silicon based solar cells produce a voltage of about 0.6 volts (V). Thus, solar cells are interconnected in series or parallel in order to achieve greater voltages. When connected in series, voltages of individual cells add together while current remains the same. Thus, solar cells arranged in series reduce the amount of current flow through such cells, compared to analogous solar cells arrange in parallel, thereby improving efficiency. As illustrated in FIG. 1A, the arrangement of solar cells in series is accomplished using interconnects 116. In general, an interconnect 116 places the first electrode of one solar cell in electrical communication with the counter-electrode of an adjoining solar cell.

As noted above, and as illustrated in FIG. 1A, conventional solar cells are typically in the form of a plate structure. Although such cells are highly efficient when they are smaller, larger planar solar cells have reduced efficiency because it is harder to make the semiconductor films that form the junction in such solar cells uniform. Furthermore, the occurrence of pinholes and similar flaws increase in larger planar solar cells. These features can cause shunts across the junction. Cylindrical solar cells obviate some of the drawbacks of planar solar cells. Fabrication techniques for cylindrical solar cells can, for example, reduce the incidence of occurrence of pinholes and similar flaws. Examples, of cylindrical solar cells are found in, for example, U.S. Pat. Nos. 6,762,359 B2 to Asia et al.; 3,976,508 to Mlavsky; 3,990,914 to Weinstein and Lee; as well as Japanese Patent Application Number S59-125670 to Toppan Printing Company.

Solar cells found in the prior art have great utility. They can be used to address some of the problems faced by utility companies. Furthermore, they provide a clean alternative source of energy that has the potential for reducing the load on coal powered, dam powered, or nuclear powered resources. In fact, solar cells can be arranged in large fields and, in this fashion, can contribute to existing utility grids. Moreover, solar cells can be used by individual home owners and building owners to reduce conventional utility costs. However, even the cylindrical solar cells found in the prior art have drawbacks that do not fully address the problems faced by utility companies and energy consumers. First, during solar radiation collection, cylindrical solar cells heat up to high temperatures. This is known as the cooling requirement. Second, when arranged in planar arrays, cylindrical solar cells often cast a shadow on neighboring cells, resulting in a reduction in the amount of solar cell surface area that is exposed to direct solar radiation. This is known as the shadowing effect. Third, it is often necessary to equip such solar cells with elaborate tracking mechanisms in order to ensure that the solar cells are facing the sun throughout the day. This is known as the tracking requirement.

Referring to FIG. 1D, the shadowing effect is described in detail. Cylindrical solar cells 1 are placed adjacent to each other on substrate 4. In the early morning or the late afternoon, incoming solar radiation 5 hits the solar cell surfaces at small angles of incidence. As a result, solar cells cast large shadows onto neighboring cells. As shown in FIG. 1D, shaded area 3 between adjacent solar cells lies in the shadow, devoid of direct solar radiation. The shadowing effect largely accounts for the early afternoon capacity peak for known solar cell systems. Peak electricity demands in many communities, however, occurs much later in the afternoon when people return home and need to cook, heat or cool their homes and when the long exposure of building rooftops to daylight begins to heat the building up, thereby increasing the load on air conditioners. The discrepancy between solar peak capacity and peak electricity demand hampers the utility of conventional cylindrical solar cells. Thus, what is needed in the art is the reduction or elimination of the shadowing effect, either by neighboring solar cells or other objects in the surroundings where the solar cells are installed.

The tracking requirement associated with many conventional cylindrical solar cell systems is disadvantageous. Tracking devices are used in the art to enhance the efficiency of solar cell systems. Tracking devices move solar cells with time to follow the movement of the sun. In order to track movement of the sun, the optic axis of the system is continuously or periodically mechanically adjusted to be directed at the sun throughout the day and year. In some embodiments, tracking devices are moved in more than one axis. Conventional tracking devices enhance the power output of solar cells. However, the periodical mechanical adjustments associated with such tracking devices require relatively complex, sometimes elaborate, and often costly structures. In addition, power is required to adjust the tracking devices, thereby reducing the overall efficiency of the system.

Each of the above drawbacks has an adverse affect on cylindrical solar cell performance and/or the cost of making cylindrical solar cells. Exemplary solar cells that have the shadowing drawback include both cylindrical and noncylindrical solar cells such as those disclosed in U.S. Pat. Nos. 6,762,359 B2 to Asia et al.; 3,976,508 to Mlavsky; 3,990,914 to Weinstein and Lee; and Japanese Patent Application Number S59-125670 to Toppan Printing Company.

Methods for cooling solar cells, such as passing a coolant through a tube within a solar cell or laying solar cells on a substrate that itself if cooled, have been disclosed in the known art. See, for example, U.S. Pat. No. 6,762,359 B2 to Asia et al. and German Unexamined Patent Application DE 43 39 547 A1 to Twin Solar-Technik Entwicklungs-GmbH, published May 24, 1995, (hereinafter “Twin Solar”). However, the systems disclosed in these references are unsatisfactory because they are costly.

Given the above background, what is needed in the art are cost effective methods and systems for cooling cylindrical solar cells and for reducing the shadowing effects that adjacent cylindrical solar cells have on each other, particularly in times of peak electrical demand. Preferably, such systems and methods have minimal tracking requirements.

Discussion or citation of a reference herein will not be construed as an admission that such reference is prior art to the present invention.

### 3. SUMMARY OF THE INVENTION

One aspect of the present invention provides a solar cell arrangement comprising a first solar cell assembly having a first plurality of cylindrical solar units arranged parallel or approximately parallel to each other in a common plane to form a first plurality of adjacent cylindrical solar unit pairs. As used herein, the term solar unit pair is simply intended to mean two solar units that are adjacent to each other in a solar cell arrangement. A solar unit can be, for example, a solar cell, a monolithically integrated solar module comprising a plurality of solar cells, or a nonmonolithically integrated solar module comprising a plurality of solar cells. A first and a second cylindrical solar unit in a number of adjacent cylindrical solar unit pairs in the first plurality of cylindrical solar units are each separated from each other by a spacer distance thereby allowing direct sunlight to pass between the cylindrical solar units. Each cylindrical solar unit in the first plurality of cylindrical solar units is at least a separation distance away from an installation surface. The separation distance is greater than the spacer distance in some embodiments. In other embodiments, the separation distance is less than the spacer distance.

In some embodiments, the solar cell arrangement further comprises a second solar unit assembly having a second plurality of cylindrical solar units arranged parallel or approximately parallel to each other in a common plane to form a second plurality of adjacent cylindrical solar unit pairs. A first and a second solar unit in a number of adjacent cylindrical solar unit pairs in the second plurality of cylindrical solar units are each separated from each other by the spacer distance thereby allowing direct sunlight to pass between the cylindrical solar units. Each cylindrical solar unit in the second plurality of cylindrical solar units is at least a separation distance away from an installation surface. Furthermore, the first solar unit assembly and the second solar unit assembly are separated from each other by a passageway distance. In some embodiments, the separation distance is greater than the passageway distance.

In some embodiments, there are 20 or more, 100 or more, or 500 or more cylindrical solar units in the solar cell arrangement. In some embodiments a cylindrical solar unit in the plurality of cylindrical solar units has a diameter of between 2 centimeters and 6 centimeters, a diameter that is 5 centimeters or larger, or a diameter that is 10 centimeters or larger. In some embodiments, the spacer distance is 0.1 centimeters or more, 1 centimeter or more, 5 centimeters or more, or less than 10 centimeters. In some embodiments, the spacer distance is at least equal to or greater than a diameter of a cylindrical solar unit in the first plurality of cylindrical solar units. In some embodiments, the spacer distance is at least equal to or greater than two times a diameter of a cylindrical solar unit in the first plurality of cylindrical solar units. In some embodiments, the spacer distance between a first and second solar unit in a first adjacent cylindrical solar units pair in the first plurality of cylindrical solar units is different than the spacer distance between a first and second cylindrical solar unit in a second adjacent cylindrical solar unit pair in the first plurality of cylindrical solar units. In some embodiments, the spacer distance between each first and second cylindrical solar unit in each adjacent cylindrical solar unit pair in the first plurality of cylindrical solar units is the same.

In some embodiments, installation surface is overlayed with an albedo surface. In some embodiments this albedo surface has an albedo of at least sixty percent. In some embodiments, the albedo surface is a Lambertian or diffuse reflector surface. In some embodiments, the albedo surface is overlayed with a self-cleaning layer. In some embodiments, the separation distance is twenty-five centimeters or more, or two meters or more.

In some embodiments, a cylindrical solar unit in the first plurality of cylindrical solar units comprises a substrate that is either (i) tubular shaped or (ii) rigid solid rod shaped, a back-electrode circumferentially disposed on the substrate, a semiconductor junction layer circumferentially disposed on the back-electrode, and a transparent conductive layer circumferentially disposed on the semiconductor junction. In some embodiments, the solar cell arrangement further comprises a transparent tubular casing circumferentially sealed onto the cylindrical shaped solar unit. In some instances, the transparent tubular casing is made of plastic or glass. In some instances, the substrate comprises plastic, glass, a metal, or a metal alloy. In some instances, the substrate is tubular shaped and a fluid is passed through the substrate. In some instances a semiconductor junction comprises an absorber layer and a junction partner layer such that the junction partner layer is circumferentially disposed on the absorber layer. In some such embodiments, the absorber layer is copper-indium-gallium-diselenide and the junction partner layer is In₂Se₃, In₂S₃, ZnS, ZnSe, CdlnS, CdZnS, ZnIn₂Se₄, Zn₁₋ₓMgₓO, CdS, SnO₂, ZnO, ZrO₂, or doped ZnO.

Still further embodiments of the present invention provide a plurality of internal reflectors. Each respective internal reflector in the plurality of internal reflectors is configured between a corresponding first and second cylindrical solar unit in the plurality of cylindrical solar units such that a portion of the solar light reflected from the respective internal reflector is reflected onto the corresponding first cylindrical solar unit. In some embodiments, an internal reflector in the plurality of internal reflectors has a hollow core. In some embodiments, an internal reflector in the plurality of internal reflectors comprises a plastic casing with a layer of reflective material deposited on the plastic casing. In some embodiments, the layer of reflective material is polished aluminum, aluminum alloy, silver, nickel or steel. In some embodiments, an internal reflector in the plurality of internal reflectors is a single piece made out of a reflective material (e.g., polished aluminum, aluminum alloy, silver, nickel or steel). In some embodiments, an internal reflector in the plurality of internal reflectors comprises a plastic casing onto which is layered a metal foil tape (e.g., aluminum foil tape).

Still another aspect of the present invention provides a solar cell arrangement comprising a solar cell assembly having a plurality of cylindrical solar units arranged parallel or approximately parallel to each other in a common plane to form a plurality of adjacent cylindrical solar unit pairs. The solar cell arrangement further comprises a box-like casing having a bottom and a plurality of transparent side panels. The box-like casing encases the solar cell assembly. A first and a second cylindrical solar unit in a number of adjacent cylindrical solar unit pairs in the first plurality of cylindrical solar units are each separated from each other by a spacer distance thereby allowing direct sunlight to pass between the cylindrical solar units onto the bottom of the box-like casing. Each cylindrical solar unit in the plurality of cylindrical solar units is at least a separation distance away from the bottom. Furthermore, the separation distance is greater than the spacer distance in some embodiments. The separation distance is less than the spacer distance in other embodiments. In some embodiments, the box-like casing further comprises a top layer that seals the box-like casing and shields the plurality of cylindrical solar units from direct solar radiation. In some embodiments, a first side of the top layer is coated with an anti-reflective coating and a second side of the top layer is coated with a reflective coating, such that the first side faces outward from the box-like casing and the second side faces into the box-like casing toward the plurality of cylindrical solar units. In some embodiments, the plurality of transparent side panels comprises transparent plastic or glass. In some embodiments, the plurality of transparent side panels comprises aluminosilicate glass, borosilicate glass, dichroic glass, germanium/semiconductor glass, glass ceramic, silicate/fused silica glass, soda lime glass, quartz glass, chalcogenide/sulphide glass, fluoride glass, flint glass, or cereated glass. In some embodiments, the plurality of transparent side panels comprises a urethane polymer, an acrylic polymer, a fluoropolymer, a polyamide, a polyolefin, polymethylmethacrylate (PMMA), a poly-dimethyl siloxane (PDMS), ethyl vinyl acetate (EVA), perfluoroalkoxy fluorocarbon (PFA), nylon/polyamide, cross-linked polyethylene (PEX), polypropylene (PP), polyethylene terephtalate glycol (PETG), polytetrafluoroethylene (PTFE), thermoplastic copolymer, a polyurethane/urethane, a transparent polyvinyl chloride (PVC), a polyvinylidene fluoride (PVDF), or any combination thereof.

### 4. BRIEF DESCRIPTION OF THE DRAWINGS

FIG. 1A illustrates interconnected solar cells in accordance with the prior art.

FIG. 1B illustrates a large scale change in electricity demand in California in 1998, in accordance with the prior art.

FIG. 1C illustrates electricity demand peaks during early evening hours around 6 PM and 7 PM in California in December of one year, in accordance with the prior art.

FIG. 1D illustrates a shadowing effect associated with prior art solar cells.

FIG. 2A illustrates the cross-sectional view of a cylindrical solar cell, in accordance with one embodiment of the present invention.

FIG. 2B illustrates perspective and cross-sectional views of a solar module, in accordance with one embodiment of the present invention.

FIG. 3A illustrates a perspective view of a solar cell assembly, in accordance with one embodiment of the present invention.

FIG. 3B illustrates a cross-sectional view of a solar cell assembly, in accordance with one embodiment of the present invention.

FIG. 3C illustrates a top view of a solar cell assembly, in accordance with one embodiment of the present invention.

FIG. 3D illustrates a partial cross-sectional view of a solar cell assembly, in accordance with one embodiment of the present invention.

FIG. 3E illustrates a partial cross-sectional view of a solar cell assembly, in accordance with one embodiment of the present invention.

FIG. 3F illustrates a partial cross-sectional view of a solar cell assembly, in accordance with one embodiment of the present invention.

FIG. 4A illustrates a perspective view of an encased solar cell assembly, in accordance with one embodiment of the present invention.

FIG. 4B illustrates a cross-sectional view of an encased solar cell assembly, in accordance with one embodiment of the present invention.

FIG. 4C illustrates a top view of an encased solar cell assembly, in accordance with one embodiment of the present invention.

FIG. 4D illustrates a partial cross-sectional view of an encased solar cell assembly, in accordance with one embodiment of the present invention.

FIG. 4E illustrates a cross-sectional view of an encased solar cell assembly with back reflectors, in accordance with one embodiment of the present invention.

FIG. 4F illustrates a cross-sectional view of an encased solar cell assembly with internal reflectors, in accordance with one embodiment of the present invention.

FIG. 5A illustrates a perspective view of a solar cell assembly on a tilt, in accordance with one embodiment of the present invention.

FIG. 5B illustrates a top view of a solar cell assembly, in accordance with one embodiment of the present invention.

FIG. 5C illustrates a side view of a solar cell assembly, in accordance with one embodiment of the present invention.

FIG. 6 illustrates a side view of an encased solar cell assembly, in accordance with one embodiment of the present invention.

FIGS. 7A-7D illustrate semiconductor junctions that are used in various solar units in embodiments of the present invention.

FIGS. 8A-8D illustrate exemplary solar cell arrangements in accordance with embodiments of the present invention.

FIGS. 9A-9C illustrate the properties of solar radiation in accordance with some embodiments of the present invention.

FIG. 10 illustrates a solar absorption profile of solar cell assemblies in accordance with an embodiment of the present invention.

FIGS. 11A-11D illustrate solar collection profiles of solar cell assemblies in accordance with embodiments of the present invention.

FIGS. 12A-12C compare annual energy absorption between prior art embodiments and embodiments in accordance with the present invention.

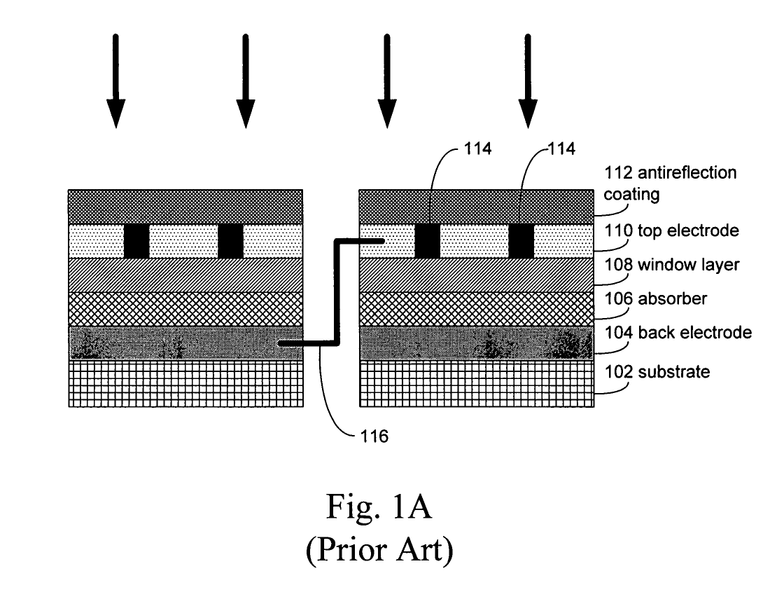

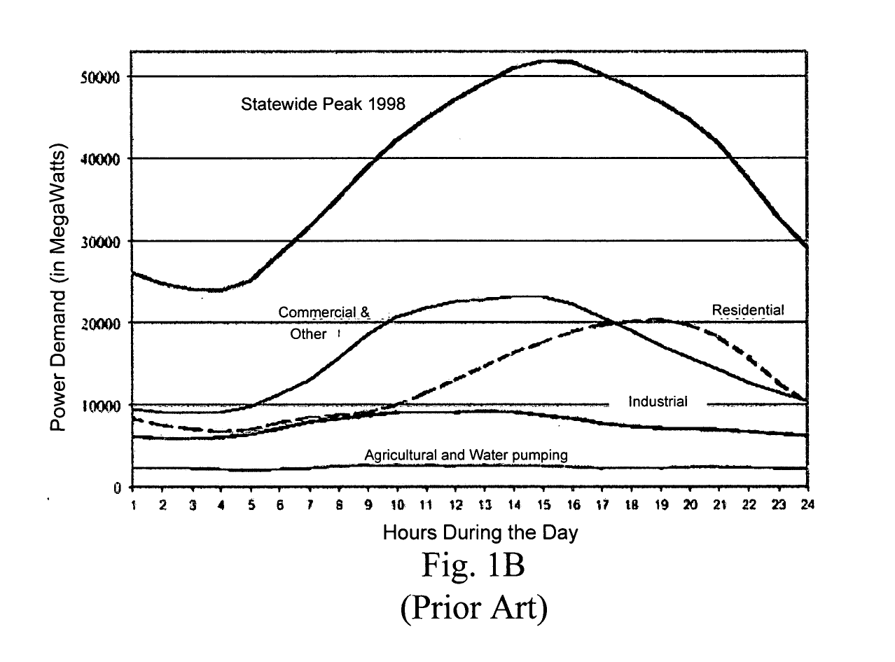

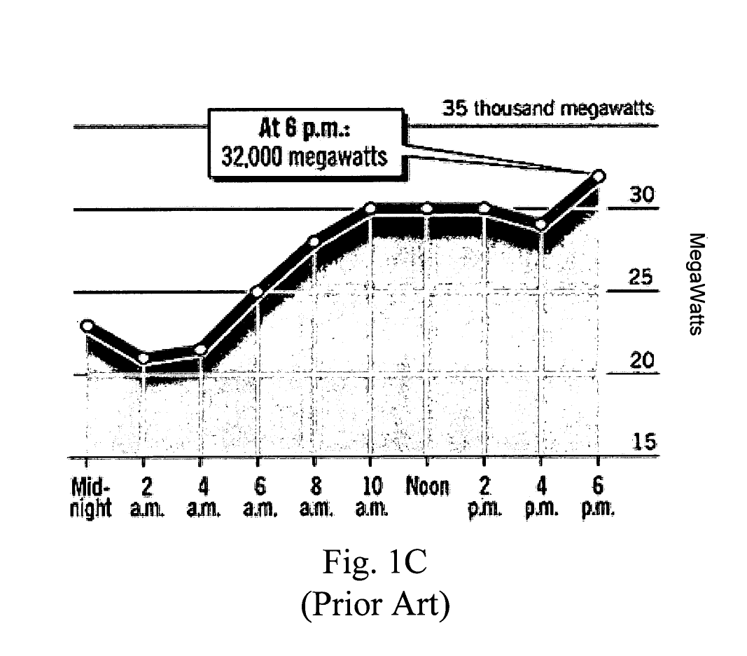

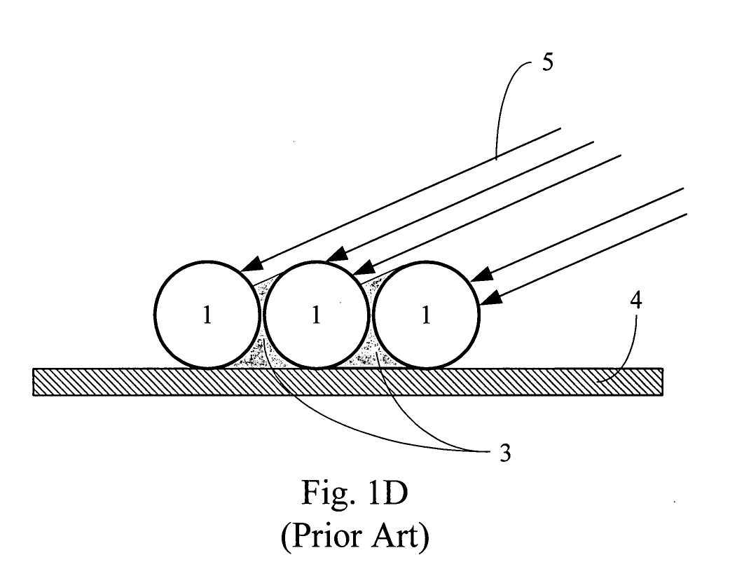

Like reference numerals refer to corresponding parts throughout the several views of the drawings. Dimensions are not drawn to scale.

### 5. DETAILED DESCRIPTION

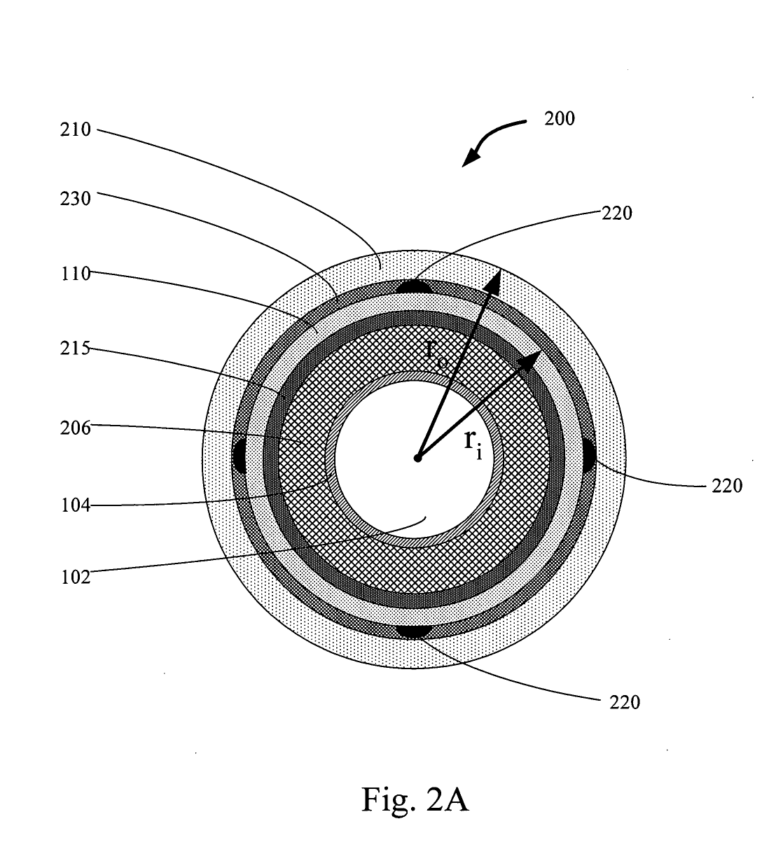

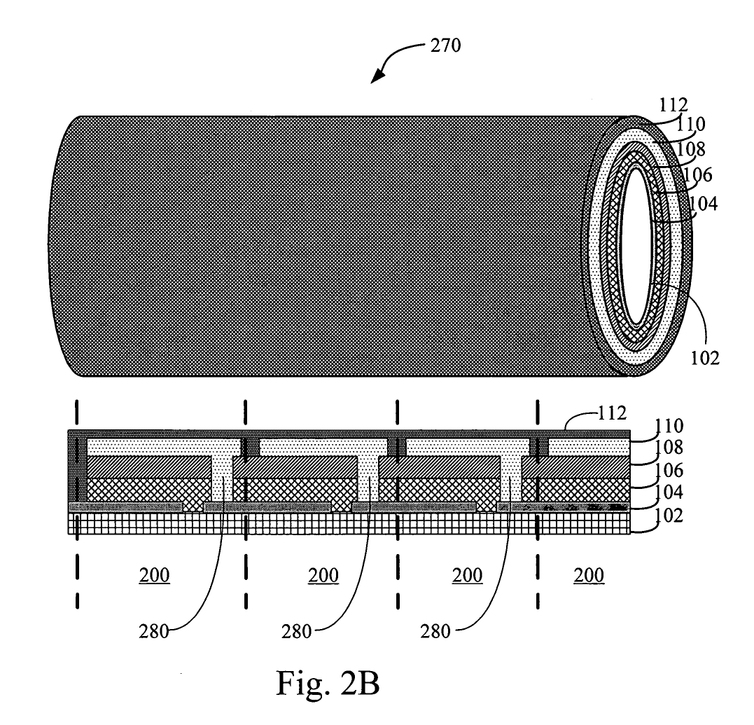

Disclosed herein are exemplary structures of elements within cylindrical solar units that form part of the novel solar cell arrangements in accordance with some embodiments of the present invention. Each cylindrical solar unit can be a solar cell as described in conjunction with FIG. 2A below or a solar module as described in conjunction with FIG. 2B, below. In some embodiments of the present invention, solar cell arrangements of the present invention comprise a single solar cell panel. In some embodiments of the present invention, solar cell arrangements of the present invention comprise a plurality of solar cell panels.

### 5.1 Basic Structure

FIG. 2A illustrates the cross-sectional view of an exemplary embodiment of a cylindrical solar unit that is a solar cell 200. In some embodiments, the cylindrical substrate is either (i) tubular shaped or (ii) a rigid solid. In some embodiments the cylindrical substrate is a flexible tube, a rigid tube, a rigid solid, or a flexible solid. As illustrated in FIG. 2A, a solar cell 200 comprises substrate 102, back-electrode 104, semiconductor junction 206, optional intrinsic layer 215, transparent conductive layer 110, optional electrode strips 220, optional filler layer 230, and optional transparent tubular casing 210. In some embodiments, a cylindrical solar unit 200 also comprises optional fluorescent coating and/or antireflective coating to further enhance absorption of solar radiation.

Cylindrical substrate 102. Cylindrical substrate 102 serves as a substrate for solar cell 200. In some embodiments, cylindrical substrate 102 is either (i) tubular shaped or (ii) a rigid solid. In some embodiments cylindrical substrate 102 is a flexible tube, a rigid tube, a rigid solid, or a flexible solid. For example, in some embodiments, cylindrical substrate 102 is a hollow flexible fiber. In some embodiments, cylindrical substrate 102 is a rigid tube made out plastic metal or glass. In some embodiments, cylindrical substrate 102 is made of a plastic, metal, metal alloy, or glass. In some embodiments, cylindrical substrate 102 is made of a urethane polymer, an acrylic polymer, a fluoropolymer, polybenzamidazole, polymide, polytetrafluoroethylene, polyetheretherketone, polyamide-imide, glass-based phenolic, polystyrene, cross-linked polystyrene, polyester, polycarbonate, polyethylene, polyethylene, acrylonitrile-butadiene-styrene, polytetrafluoro-ethylene, polymethacrylate, nylon 6,6, cellulose acetate butyrate, cellulose acetate, rigid vinyl, plasticized vinyl, or polypropylene. In some embodiments, cylindrical substrate 102 is made of aluminosilicate glass, borosilicate glass, dichroic glass, germanium/semiconductor glass, glass ceramic, silicate/fused silica glass, soda lime glass, quartz glass, chalcogenide/sulphide glass, fluoride glass, a glass-based phenolic, flint glass, or cereated glass.

In some embodiments, cylindrical substrate 102 is made of a material such as polybenzamidazole (e.g., Celazole®, available from Boedeker Plastics, Inc., Shiner, Tex.). In some embodiments, cylindrical substrate 102 is made of polymide (e.g., DuPont™ Vespel®, or DuPont™ Kapton®, Wilmington, Del.). In some embodiments, cylindrical substrate 102 is made of polytetrafluoroethylene (PTFE) or polyetheretherketone (PEEK), each of which is available from Boedeker Plastics, Inc. In some embodiments, cylindrical substrate 102 is made of polyamide-imide (e.g., Torlon® PAI, Solvay Advanced Polymers, Alpharetta, Ga.).

In some embodiments, cylindrical substrate 102 is made of a glass-based phenolic. Phenolic laminates are made by applying heat and pressure to layers of paper, canvas, linen or glass cloth impregnated with synthetic thermosetting resins. When heat and pressure are applied to the layers, a chemical reaction (polymerization) transforms the separate layers into a single laminated material with a “set” shape that cannot be softened again. Therefore, these materials are called “thermosets.” A variety of resin types and cloth materials can be used to manufacture thermoset laminates with a range of mechanical, thermal, and electrical properties. In some embodiments, the inner core is a phenoloic laminate having a NEMA grade of G-3, G-5, G-7, G-9, G-10 or G-11. Exemplary phenolic laminates are available from Boedeker Plastics, Inc.

In some embodiments, cylindrical substrate 102 is made of polystyrene. Examples of polystyrene include general purpose polystyrene and high impact polystyrene as detailed in Marks' Standard Handbook for Mechanical Engineers, ninth edition, 1987, McGraw-Hill, Inc., pp. 6-174, which is hereby incorporated by reference herein in its entirety. In still other embodiments, substrate 102 is made of cross-linked polystyrene. One example of cross-linked polystyrene is Rexolite® (available from San Diego Plastics Inc., National City, Calif.). Rexolite is a thermoset, in particular a rigid and translucent plastic produced by cross linking polystyrene with divinylbenzene.

In some embodiments, substrate 102 is a polyester wire (e.g., a Mylar® wire). Mylar® is available from DuPont Teijin Films (Wilmington, Del.). In still other embodiments, cylindrical substrate 102 is made of Durastone®, which is made by using polyester, vinylester, epoxid and modified epoxy resins combined with glass fibers (Roechling Engineering Plastic Pte Ltd. (Singapore).

In still other embodiments, cylindrical substrate 102 is made of polycarbonate. Such polycarbonates can have varying amounts of glass fibers (e.g., 10%, 20%, 30%, or 40%) in order to adjust tensile strength, stiffness, compressive strength, as well as the thermal expansion coefficient of the material. Exemplary polycarbonates are Zelux® M and Zelux® W, which are available from Boedeker Plastics, Inc.

In some embodiments, cylindrical substrate 102 is made of polyethylene. In some embodiments, cylindrical substrate 102 is made of low density polyethylene (LDPE), high density polyethylene (HDPE), or ultra high molecular weight polyethylene (UHMW PE). Chemical properties of HDPE are described in Marks' Standard Handbook for Mechanical Engineers, ninth edition, 1987, McGraw-Hill, Inc., pp. 6-173, which is hereby incorporated by reference herein in its entirety. In some embodiments, cylindrical substrate 102 is made of acrylonitrile-butadiene-styrene, polytetrifluoro-ethylene (Teflon), polymethacrylate (lucite or plexiglass), nylon 6,6, cellulose acetate butyrate, cellulose acetate, rigid vinyl, plasticized vinyl, or polypropylene. Chemical properties of these materials are described in Marks' Standard Handbook for Mechanical Engineers, ninth edition, 1987, McGraw-Hill, Inc., pp. 6-172 through 1-175, which is hereby incorporated by reference in its entirety.

Additional exemplary materials that can be used to form cylindrical substrate 102 are found in Modern Plastics Encyclopedia, McGraw-Hill; Reinhold Plastics Applications Series, Reinhold Roff, Fibres, Plastics and Rubbers, Butterworth; Lee and Neville, Epoxy Resins, McGraw-Hill; Bilmetyer, Textbook of Polymer Science, Interscience; Schmidt and Marlies, Principles of high polymer theory and practice, McGraw-Hill; Beadle (ed.), Plastics, Morgan-Grampiand, Ltd., 2 vols. 1970; Tobolsky and Mark (eds.), Polymer Science and Materials, Wiley, 1971; Glanville, The Plastics's Engineer's Data Book, Industrial Press, 1971; Mohr (editor and senior author), Oleesky, Shook, and Meyers, SPI Handbook of Technology and Engineering of Reinforced Plastics Composites, Van Nostrand Reinhold, 1973, each of which is hereby incorporated by reference herein in its entirety.

Back-electrode 104. Back-electrode 104 is circumferentially disposed on cylindrical substrate 102. Back-electrode 104 serves as the first electrode. In general, back-electrode 104 is made out of any material that can support the photovoltaic current generated by cylindrical solar cell 200 with negligible resistive losses. In some embodiments, back-electrode 104 is composed of any conductive material, such as aluminum, molybdenum, tungsten, vanadium, rhodium, niobium, chromium, tantalum, titanium, steel, nickel, platinum, silver, gold, an alloy thereof, or any combination thereof. In some embodiments, back-electrode 104 is composed of any conductive material, such as indium tin oxide, titanium nitride, tin oxide, fluorine doped tin oxide, doped zinc oxide, aluminum doped zinc oxide, gallium doped zinc oxide, boron dope zinc oxide indium-zinc oxide, a metal-carbon black-filled oxide, a graphite-carbon black-filled oxide, a carbon black-carbon black-filled oxide, a superconductive carbon black-filled oxide, an epoxy, a conductive glass, or a conductive plastic. As defined herein, a conductive plastic is one that, through compounding techniques, contains conductive fillers which, in turn, impart their conductive properties to the plastic. In some embodiments, the conductive plastics used in the present invention to form back-electrode 104 contain fillers that form sufficient conductive current-carrying paths through the plastic matrix to support the photovoltaic current generated by cylindrical solar cell 200 with negligible resistive losses. The plastic matrix of the conductive plastic is typically insulating, but the composite produced exhibits the conductive properties of the filler.

Semiconductor junction 206. Semiconductor junction 206 is formed around back-electrode 104. Semiconductor junction 206 is any photovoltaic homojunction, heterojunction, heteroface junction, buried homojunction, a p-i-n junction or a tandem junction having an absorber layer 106 that is a direct band-gap absorber (e.g., crystalline silicon) or an indirect band-gap absorber (e.g., amorphous silicon). Such junctions are described in Chapter 1 of Bube, Photovoltaic Materials, 1998, Imperial College Press, London, as well as Lugue and Hegedus, 2003, Handbook of Photovoltaic Science and Engineering, John Wiley & Sons, Ltd., West Sussex, England, each of which is hereby incorporated by reference in its entirety.

In some embodiments, the semiconductor junction comprises an absorber layer 106 and a junction partner layer 108, where the junction partner layer 108 is circumferentially disposed on the absorber layer 106. In some embodiments, the absorber layer 106 is copper-indium-gallium-diselenide (CIGS) and junction partner layer 108 is In₂Se₃, In₂S₃, ZnS, ZnSe, CdlnS, CdZnS, ZnIn₂Se₄, Zn₁₋ₓMgₓO, CdS, SnO₂, ZnO, ZrO₂, or doped ZnO. In some embodiments, absorber layer 108 is between 0.5 μm and 2.0 μm thick. In some embodiments a composition ratio of Cu/(In+Ga) in absorber layer 108 is between 0.7 and 0.95. In some embodiments, a composition ratio of Ga/(In+Ga) in absorber layer 108 is between 0.2 and 0.4. In some embodiments, absorber layer 108 comprises CIGS having a <110> crystallographic orientation, a <112> crystallographic orientation, or CIGS that is randomly oriented.

Details of exemplary types of semiconductors junctions 206 in accordance with the present invention are disclosed in Section 5.4, below. In addition to the exemplary junctions disclosed in Section 5.4, below, junctions 206 can be multijunctions in which light traverses into the core of junction 206 through multiple junctions that, preferably, have successfully smaller band gaps.

Optional intrinsic layer 215. Optionally, there is a thin intrinsic layer (i-layer) 215 circumferentially disposed on semiconductor junction 206. The i-layer 215 can be formed using any undoped transparent oxide including, but not limited to, zinc oxide, metal oxide, or any transparent material that is highly insulating. In some embodiments, i-layer 215 is highly pure zinc oxide.

Transparent conductive layer 110. A transparent conductive layer 110 is circumferentially disposed on the semiconductor junction layers 206 thereby completing the circuit of solar cell 200. As noted above, in some embodiments, a thin i-layer 215 is circumferentially disposed on semiconductor junction 206. In such embodiments, transparent conductive layer 110 is circumferentially disposed on i-layer 215. In some embodiments, transparent conductive layer 110 is made of carbon nanotubes, tin oxide SnOₓ (with or without fluorine doping), indium-tin oxide (ITO), doped zinc oxide (e.g., aluminum doped zinc oxide), indium-zinc oxide, doped zinc oxide, aluminum doped zinc oxide, gallium doped zinc oxide, boron dope zinc oxide, or any combination thereof. Carbon nanotubes are commercially available, for example from Eikos (Franklin, Mass.) and are described in U.S. Pat. No. 6,988,925, which is hereby incorporated by reference herein in its entirety. In some embodiments, transparent conductive layer 110 is either p-doped or n-doped. For example, in embodiments where the outer semiconductor layer of junction 206 is p-doped, transparent conductive layer 110 can be p-doped. Likewise, in embodiments where the outer semiconductor layer of junction 206 is n-doped, transparent conductive layer 110 can be n-doped. In general, transparent conductive layer 110 is preferably made of a material that has very low resistance, suitable optical transmission properties (e.g., greater than 90%), and a deposition temperature that will not damage underlying layers of semiconductor junction 206 and/or optional i-layer 215. In some embodiments, transparent conductive layer 110 is an electrically conductive polymer material such as a conductive polytiophene, a conductive polyaniline, a conductive polypyrrole, a PSS-doped PEDOT (e.g., Bayrton), or a derivative of any of the foregoing. In some embodiments, transparent conductive layer 110 comprises more than one layer, including a first layer comprising tin oxide SnOₓ (with or without fluorine doping), indium-tin oxide (ITO), indium-zinc oxide, doped zinc oxide (e.g., aluminum doped zinc oxide) or a combination thereof and a second layer comprising a conductive polytiophene, a conductive polyaniline, a conductive polypyrrole, a PSS-doped PEDOT (e.g., Bayrton), or a derivative of any of the foregoing. Additional suitable materials that can be used to form transparent conductive layer 110 are disclosed in United States Patent publication 2004/0187917A1 to Pichler, which is hereby incorporated by reference herein in its entirety.

Optional electrode strips 220. In some embodiments in accordance with the present invention, counter electrode strips or leads 220 are disposed on transparent conductive layer 110 in order to facilitate electrical current flow. In some embodiments, counter electrode strips 220 are thin strips of electrically conducting material that run lengthwise along the long axis (cylindrical axis) of the elongated solar cell. In some embodiments, optional electrode strips are positioned at spaced intervals on the surface of transparent conductive layer 110. For instance, in FIG. 2A, counter electrode strips 220 run parallel to each other and are spaced out at ninety-degree intervals along the cylindrical axis of the solar cell. In some embodiments, counter electrode strips 220 are spaced out at five degree, ten degree, fifteen degree, twenty degree, thirty degree, forty degree, fifty degree, sixty degree, ninety degree or 180 degree intervals on the surface of transparent conductive layer 110. In some embodiments, there is a single counter electrode strip 220 on the surface of transparent conductive layer 110. In some embodiments, there is no counter electrode strip 220 on the surface of transparent conductive layer 110. In some embodiments, there is two, three, four, five, six, seven, eight, nine, ten, eleven, twelve, fifteen or more, or thirty or more counter electrode strips on transparent conductive layer 110, all running parallel, or near parallel, to each down the long (cylindrical) axis of the solar cell. In some embodiments, counter electrode strips 220 are evenly spaced about the circumference of transparent conductive layer 110, for example, as illustrated in FIG. 2A. In alternative embodiments, counter electrode strips 220 are not evenly spaced about the circumference of transparent conductive layer 110. In some embodiments, counter electrode strips 220 are only on one face of cylindrical solar cell 200. Elements 102, 104, 206, 215 (optional), and 110 of FIG. 2A collectively comprise solar cell 200 of FIG. 2A in some embodiments. In some embodiments, counter electrode strips 220 are made of conductive epoxy, conductive ink, copper or an alloy thereof, aluminum or an alloy thereof, nickel or an alloy thereof, silver or an alloy thereof, gold or an alloy thereof, a conductive glue, or a conductive plastic.

In some embodiments, there are counter electrode strips that run along the long (cylindrical) axis of cylindrical solar cell 200. These counter electrode strips are interconnected to each other by grid lines. These grid lines can be thicker than, thinner than, or the same width as the counter electrode strips. These grid lines can be made of the same or different electrically material as the counter electrode strips 220.

Optional filler layer 230. In some embodiments of the present invention, as illustrated in FIG. 2A, a filler layer 230 of sealant such as ethyl vinyl acetate (EVA), silicone, silicone gel, epoxy, polydimethyl siloxane (PDMS), RTV silicone rubber, polyvinyl butyral (PVB), thermoplastic polyurethane (TPU), a polycarbonate, an acrylic, a fluoropolymer, and/or a urethane is circumferentially disposed on transparent conductive layer 110 to seal out air. In some embodiments, filler layer 230 is a Q-type silicone, a silsequioxane, a D-type silicon, or an M-type silicon. However, in some embodiments, optional filler layer 230 is not needed even when one or more electrode strips 220 are present. Additional suitable materials for optional filler layer are described in co-pending United States patent application serial number to be determined, attorney docket number 11653-008-999, entitled “Elongated Photovoltaic Cells in Tubular Casings,” filed Mar. 18, 2006, which is hereby incorporated herein by reference in its entirety.

Optional transparent tubular casing 210. In some embodiments that do not have an optional filler layer 230, transparent tubular casing 210 is circumferentially disposed on transparent conductive layer 110. In some embodiments that do have optional filler layer 230, transparent tubular casing 210 is circumferentially disposed on optional filler layer 230. In some embodiments tubular casing 210 is made of plastic or glass. In some embodiments, solar cells 200 are sealed in transparent tubular casing 210. As shown in FIG. 2A, transparent tubular casing 210 forms the outermost layer of solar cell 200 in some embodiments. Methods, such as heat shrinking, injection molding, or vacuum loading, can be used to construct transparent tubular casing 210 such that they exclude oxygen and water from the system as well as to provide complementary fitting to the underlying layer of solar cell 200.

In some embodiments, optional transparent tubular casing 210 is made of aluminosilicate glass, borosilicate glass, dichroic glass, germanium/semiconductor glass, glass ceramic, silicate/fused silica glass, soda lime glass, quartz glass, chalcogenide/sulphide glass, fluoride glass, flint glass, or cereated glass. In some embodiments, transparent tubular casing 210 is made of a urethane polymer, an acrylic polymer, a fluoropolymer, a silicone, a silicone gel, an epoxy, a polyamide, or a polyolefin.

In some embodiments, optional transparent tubular casing 210 is made of a urethane polymer, an acrylic polymer, polymethylmethacrylate (PMMA), a fluoropolymer, silicone, poly-dimethyl siloxane (PDMS), silicone gel, epoxy, ethyl vinyl acetate (EVA), perfluoroalkoxy fluorocarbon (PFA), nylon/polyamide, cross-linked polyethylene (PEX), polyolefin, polypropylene (PP), polyethylene terephtalate glycol (PETG), polytetrafluoroethylene (PTFE), thermoplastic copolymer (for example, ETFE® which is a derived from the polymerization of ethylene and tetrafluoroethylene: TEFLON® monomers), polyurethane/urethane, polyvinyl chloride (PVC), polyvinylidene fluoride (PVDF), Tygon®, vinyl, Viton®, or any combination or variation thereof. Additional suitable materials for optional filler layer 230 are disclosed in copending United States patent application serial number to be determined, attorney docket number 11653-008-999, entitled “Elongated Photovoltaic Cells in Tubular Casing,” filed Mar. 18, 2006, which is hereby incorporated herein by reference in its entirety.

In some embodiments, transparent tubular casing 210 comprises a plurality of transparent tubular casing layers. In some embodiments, each transparent tubular casing is composed of a different material. For example, in some embodiments, transparent tubular casing 210 comprises a first transparent tubular casing layer and a second transparent tubular casing layer. Depending on the exact configuration of the solar cell, the first transparent tubular casing layer is disposed on transparent conductive layer 110, optional filler layer 230 or the water resistant layer. The second transparent tubular casing layer is disposed on the first transparent tubular casing layer.

In some embodiments, each transparent tubular casing layer has different properties. In one example, the outer transparent tubular casing layer has UV shielding properties whereas the inner transparent tubular casing layer has water proofing characteristics. Moreover, the use of multiple transparent tubular casing layers can be used to reduce costs and/or improve the overall properties of transparent tubular casing 210. For example, one transparent tubular casing layer may be made of an expensive material that has a desired physical property. By using one or more additional transparent tubular casing layers, the thickness of the expensive transparent tubular casing layer may be reduced, thereby achieving a savings in material costs. In another example, one transparent tubular casing layer may have excellent optical properties (e.g., index of refraction, etc.) but be very heavy. By using one or more additional transparent tubular casing layers, the thickness of the heavy transparent tubular casing layer may be reduced, thereby reducing the overall weight of transparent tubular casing 210.

Optional water resistant layer. In some embodiments, solar cell 200 includes one or more layers of water resistant layer to prevent the damaging effects of water molecules. In some embodiments, this water resistant layer is circumferentially disposed onto transparent conductive layer 110 prior to depositing optional filler layer 230 and optionally encasing solar cell 200 in transparent tubular casing 310. In some embodiments, such water resistant layers are circumferentially disposed onto optional filler layer 230 prior optionally encasing the cell in transparent tubular casing 210. In some embodiments, such water resistant layers are circumferentially disposed onto transparent tubular casing 210 itself to thereby form solar cell 200. In embodiments where a water resistant layer is provided to seal molecular water from inner layers of solar cell, it is important that the optical properties of the water resistant layer not interfere with the absorption of incident solar radiation by solar cell 200. In some embodiments, this water resistant layer is made of clear silicone. For example, in some embodiments, the water resistant layer is made of a Q-type silicone, a silsequioxane, a D-type silicon, or an M-type silicon. In some embodiments, the water resistant layer is made of clear silicone, SiN, SiOₓN_{y}, SiOₓ, or Al₂O₃, where x and y are integers.

Optional antireflective coating. In some embodiments, solar cell includes one or more antireflective coating layers in order to maximize solar cell efficiency. In some embodiments, solar cell includes both a water resistant layer and an antireflective coating. In some embodiments, a single layer serves the dual purpose of a water resistant layer and an anti-reflective coating. In some embodiments, antireflective coating is made of MgF₂, silicone nitrate, titanium nitrate, silicon monoxide, or silicone oxide nitrite. In some embodiments, there is more than one layer of antireflective coating. In some embodiments, there is more than one layer of antireflective coating and each layer is made of the same material. In some embodiments, there is more than one layer of antireflective coating and each layer is made of a different material. In some embodiments, antireflective coating is circumferentially disposed on layer 110, layer 230, and/or layer 210.

Optional fluorescent material. In some embodiments, a fluorescent material (e.g., luminescent material, phosphorescent material) is coated on a surface of a layer of solar cell 200. In some embodiments, solar cells 200 includes a transparent tubular casing 210 and the fluorescent material is coated on the luminal surface and/or the exterior surface of the transparent tubular casing 210. In some embodiments, the fluorescent material is coated on the outside surface of the transparent conductive oxide. In some embodiments, solar cells 200 includes a transparent tubular casing 210 and optional filler layer 230 and the fluorescent material is coated on the optional filler layer. In some embodiments, solar cells 200 includes a water resistant layer and the fluorescent material is coated on the water resistant layer. In some embodiments, more than one surface of a solar cells 200 is coated with optional fluorescent material. In some embodiments, the fluorescent material absorbs blue and/or ultraviolet light, which some semiconductor junctions 206 of the present invention do not use to convert to electricity, and the fluorescent material emits light in visible and/or infrared light which is useful for electrical generation in some solar cells 200 of the present invention.

Fluorescent, luminescent, or phosphorescent materials can absorb light in the blue or UV range and emit the visible light. Phosphorescent materials, or phosphors, usually comprise a suitable host material and an activator material. The host materials are typically oxides, sulfides, selenides, halides or silicates of zinc, cadmium, manganese, aluminum, silicon, or various rare earth metals. The activators are added to prolong the emission time.

In some embodiments, phosphorescent materials are incorporated in the systems and methods of the present invention to enhance light absorption by solar cells 200. In some embodiments, the phosphorescent material is directly added to the material used to make optional transparent tubular casing 210. In some embodiments, the phosphorescent materials are mixed with a binder for use as transparent paints to coat various outer or inner layers of each solar cell 200, as described above.

Exemplary phosphors include, but are not limited to, copper-activated zinc sulfide (ZnS:Cu) and silver-activated zinc sulfide (ZnS:Ag). Other exemplary phosphorescent materials include, but are not limited to, zinc sulfide and cadmium sulfide (ZnS:CdS), strontium aluminate activated by europium (SrAlO₃:Eu), strontium titanium activated by praseodymium and aluminum (SrTiO3:Pr, Al), calcium sulfide with strontium sulfide with bismuth ((Ca,Sr)S:Bi), copper and magnesium activated zinc sulfide (ZnS:Cu,Mg), or any combination thereof.

Methods for creating phosphor materials are known in the art. For example, methods of making ZnS:Cu or other related phosphorescent materials are described in U.S. Pat. Nos. 2,807,587 to Butler et al.; 3,031,415 to Morrison et al.; 3,031,416 to Morrison et al.; 3,152,995 to Strock; 3,154,712 to Payne; 3,222,214 to Lagos et al.; 3,657,142 to Poss; 4,859,361 to Reilly et al., and 5,269,966 to Karam et al., each of which is hereby incorporated by reference herein in its entirety. Methods for making ZnS:Ag or related phosphorescent materials are described in U.S. Pat. Nos. 6,200,497 to Park et al., 6,025,675 to Ihara et al.; 4,804,882 to Takahara et al., and 4,512,912 to Matsuda et al., each of which is hereby incorporated herein by reference in its entirety. Generally, the persistence of the phosphor increases as the wavelength decreases. In some embodiments, quantum dots of CdSe or similar phosphorescent material can be used to get the same effects. See Dabbousi et al., 1995, “Electroluminescence from CdSe quantum-dot/polymer composites,” Applied Physics Letters 66 (11): 1316-1318; Dabbousi et al., 1997 “(CdSe)ZnS Core-Shell Quantum Dots: Synthesis and Characterization of a Size Series of Highly Luminescent Nanocrystallites,” J. Phys. Chem. B, 101: 9463-9475; Ebenstein et al., 2002, “Fluorescence quantum yield of CdSe:ZnS nanocrystals investigated by correlated atomic-force and single-particle fluorescence microscopy,” Applied Physics Letters 80: 4033-4035; and Peng et al., 2000, “Shape control of CdSe nanocrystals,” Nature 404: 59-61; each of which is hereby incorporated by reference herein in its entirety.

In some embodiments, optical brighteners can be used in the optional fluorescent layers of the present invention. Optical brighteners (also known as optical brightening agents, fluorescent brightening agents or fluorescent whitening agents) are dyes that absorb light in the ultraviolet and violet region of the electromagnetic spectrum, and re-emit light in the blue region. Such compounds include stilbenes (e.g., trans-1,2-diphenylethylene or (E)-1,2-diphenylethene). Another exemplary optical brightener that can be used in the optional fluorescent layers of the present invention is umbelliferone (7-hydroxycoumarin), which also absorbs energy in the UV portion of the spectrum. This energy is then re-emitted in the blue portion of the visible spectrum. More information on optical brighteners is in Dean, 1963, Naturally Occurring Oxygen Ring Compounds, Butterworths, London; Joule and Mills, 2000, Heterocyclic Chemistry, 4^{th} edition, Blackwell Science, Oxford, United Kingdom; and Barton, 1999, Comprehensive Natural Products Chemistry 2: 677, Nakanishi and Meth-Cohn eds., Elsevier, Oxford, United Kingdom, 1999, each of which is hereby incorporated by reference herein in its entirety.

Circumferentially disposed. In the present invention, layers of material are successively circumferentially disposed on a cylindrical substrate in order to form a solar cell. As used herein, the term circumferentially disposed is not intended to imply that each such layer of material is necessarily deposited on an underlying layer. In fact, the present invention teaches methods by which some such layers can be molded or otherwise formed on an underlying layer. Nevertheless, the term circumferentially disposed means that an overlying layer is disposed on an underlying layer such that there is no annular space between the overlying layer and the underlying layer. Furthermore, as used herein, the term circumferentially disposed means that an overlying layer is disposed on at least fifty percent of the perimeter of the underlying layer in a given solar cell. Furthermore, as used herein, the term circumferentially disposed means that an overlying layer is disposed along at least half of the length of the underlying layer in a given solar cell.

Circumferentially sealed. In the present invention, the term circumferentially sealed is not intended to imply that an overlying layer or structure is necessarily deposited on an underlying layer or structure. In fact, such layers or structures (e.g., transparent tubular casing 210) can be molded or otherwise formed on an underlying layer or structure. Nevertheless, the term circumferentially sealed means that an overlying layer or structure is disposed on an underlying layer or structure such that there is no annular space between the overlying layer or structure and the underlying layer or structure. Furthermore, as used herein, the term circumferentially sealed means that an overlying layer is disposed on the full perimeter of the underlying layer. In typical embodiments, a layer or structure circumferentially seals an underlying layer or structure when it is circumferentially disposed around the full perimeter of the underlying layer or structure and along the full length of the underlying layer or structure within a given solar cell. However, the present invention contemplates embodiments in which a circumferentially sealing layer or structure does not extend along the full length of an underlying layer or structure within a given solar cell.

In some embodiments, a solar unit within the scope of the present invention is a solar module. As used herein, the term solar module means a plurality of solar cells in electrical communication with each other on a cylindrical substrate. This plurality of solar cells can be monolithically integrated or not monolithically integrated.

Referring to FIG. 2B, in some embodiments, a solar unit within the scope of the present invention is a monolithically integrated solar module 270 that, in turn, comprises a plurality of solar cells 200 linearly arranged on cylindrical substrate 102 in a monolithically integrated manner. Referring to FIG. 2B, solar modules 270 comprise a substrate 102 common to a plurality of cylindrical photovoltaic cells 200. Substrate 102 has a first end and a second end. The plurality of cylindrical solar cells 200 are linearly arranged on substrate 102 as illustrated in FIG. 2B. The plurality of solar cells 200 comprises a first and second cylindrical solar cell 200. Each cylindrical solar cell 200 in the plurality of cylindrical solar cells 200 comprises a back-electrode 104 circumferentially disposed on common cylindrical substrate 102 and a semiconductor junction 206 circumferentially disposed on back-electrode 104. In the case of FIG. 2B, semiconductor junction 206 comprises an absorber 106 and a window layer 108. Each cylindrical solar cell 200 in the plurality of cylindrical solar cells 200 further comprises a transparent conductive layer 110 circumferentially disposed on the semiconductor junction 206. In the case of FIG. 2B, transparent conductive layer 110 of first cylindrical solar cell 200 is in serial electrical communication with the back-electrode of the second photovoltaic cell in the plurality of solar cells through vias 280. In some embodiments, each via 280 extends the full circumference of the solar cell. In some embodiments, each via 280 does not extend the full circumference of the solar cell. In fact, in some embodiments, each via only extends a small percentage of the circumference of the solar cell. In some embodiments, each cylindrical solar cell 200 may have one, two, three, four or more, ten or more, or one hundred or more vias 280 that electrically connect in series the transparent conductive layer 110 of cylindrical photovoltaic cell 200 with back-electrode 104 of an adjacent cylindrical photovoltaic cell 199. FIG. 2B just represents one solar module 270 configuration. Additional solar module configurations 270 are disclosed in U.S. patent application Ser. No. to be determined, attorney docket number 11653-007-999 entitled “Monolithic Integration of Cylindrical Solar Cells,” filed Mar. 18, 2006, which is hereby incorporated by reference herein in its entirety.

### 5.2 Solar Cell System with Spatial Separation

In order to optimize absorption of solar radiation, cylindrical solar units are used to form solar cell assemblies. To further improve the solar radiation absorption properties of such assemblies, the cylindrical solar units in the solar cell assemblies disclosed in the present invention are arranged such that they are spatially separated from each other. In some embodiments, a cylindrical solar unit of the present invention is a monolithically integrated solar module 270 described in conjunction with FIG. 2B, above. In some embodiments a solar unit of the present invention is not monolithically integrated. In such embodiments, the solar unit has the structure described in conjunction with FIG. 2A above along all or a portion of the length of the cylindrical axis of the solar unit. It is to be understood that a solar unit can be a solar cell 200 as described in conjunction with FIG. 2A in which there is only a single solar cell on a substrate, or, a solar unit can, in fact, be a solar module 270 in which there are a plurality of solar cells along the length of the cylindrical axis of a substrate, where each such solar cell in the solar module has the layers of a solar cell 200 described above in conjunction with FIG. 2A. In some assemblies, there is a mixture of solar cells 200 (nonmonolithic) and solar modules 270 (monolithic). For sake of identifying solar units in the present invention in the figures that follow, solar units will be labeled “solar units 1000.” It will be understood by those of skill in the art that such solar units 1000 could be solar modules 270 (e.g., monolithic as in FIG. 2B or other monolithic configurations) or individual solar cells 200 (nonmonolithic as in FIG. 2A or other nonmonolithic configurations).

5.2.1 Spacer-Separated Solar Assemblies that are not Encased

In some embodiments in accordance with the present invention, cylindrical solar units 1000 are arranged such that adjacent parallel solar units 1000 are spatially separated from each other. In some embodiments, each of the cylindrical solar units 1000 comprises any of the configurations set forth in Section 5.1. Cylindrical solar units 1000 are arranged into assemblies that can be installed in numerous configurations.

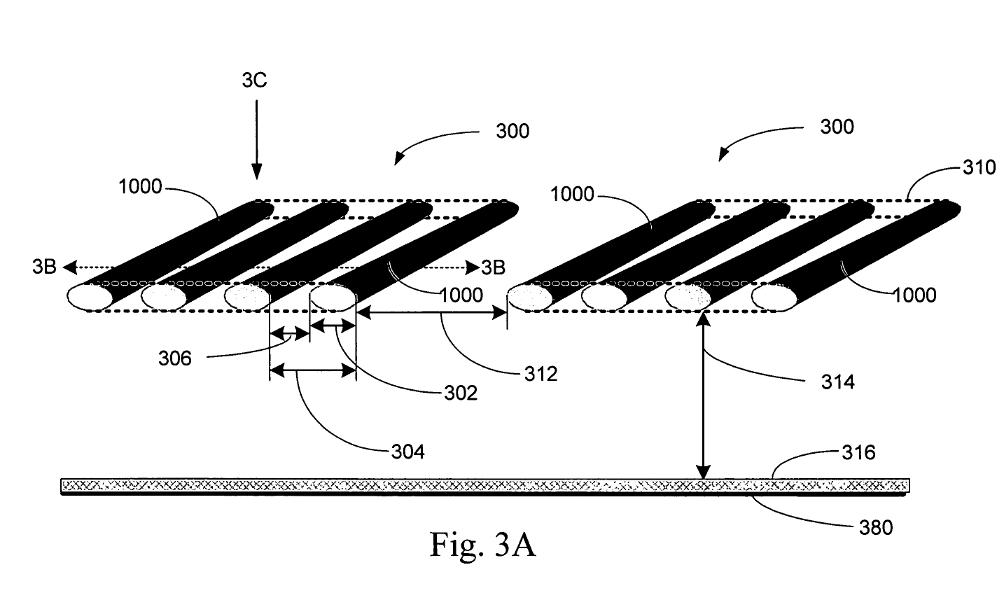

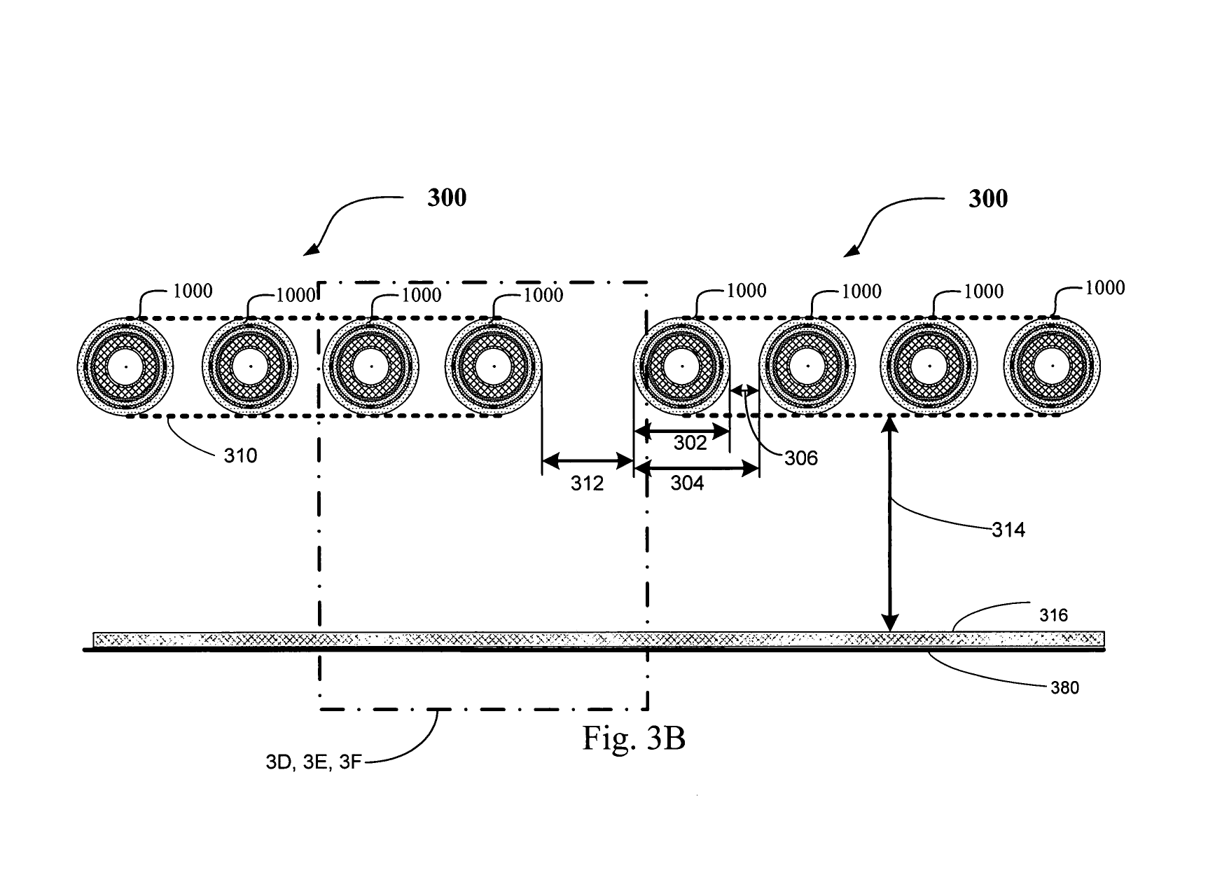

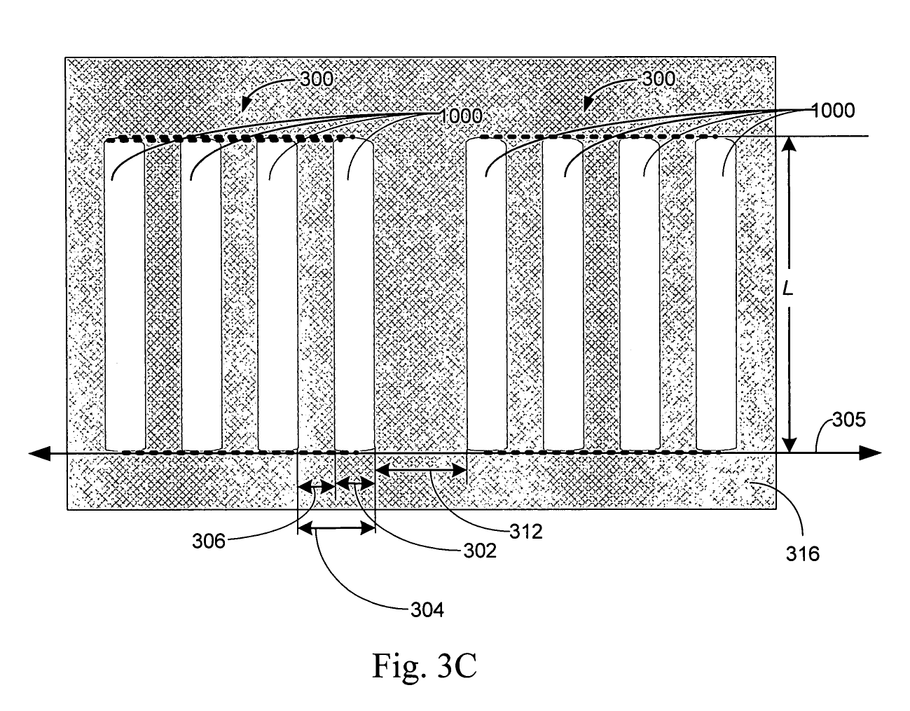

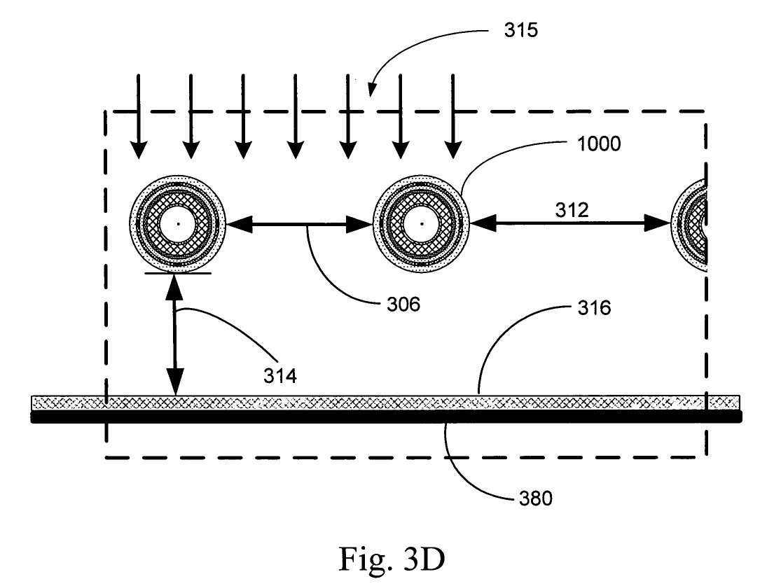

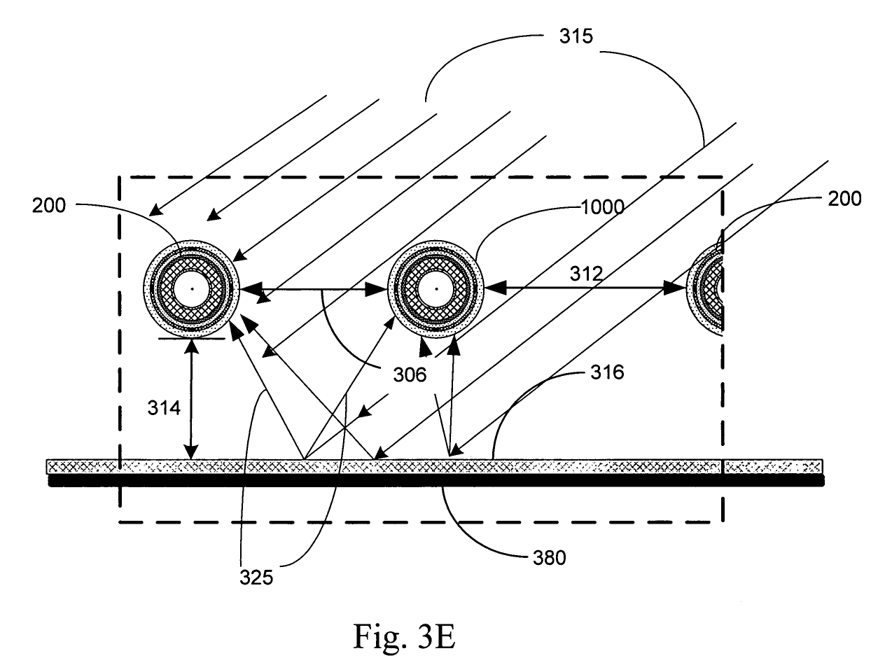

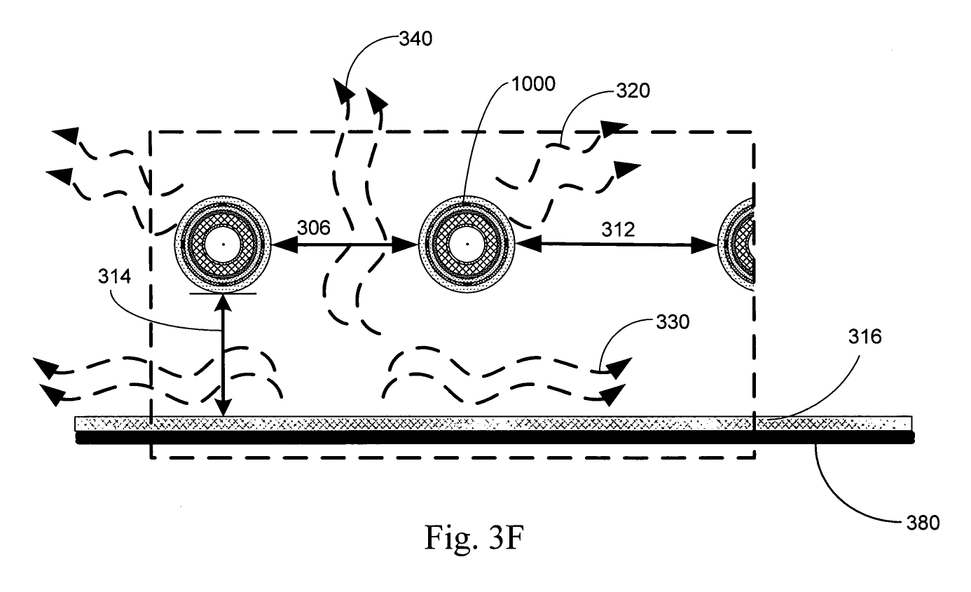

FIG. 3A illustrates solar cell assemblies 300 in accordance with one embodiment of the present invention. Each solar cell assembly 300 comprises cylindrical solar units 1000 that are arranged parallel to each other in a coplanar fashion. There is a cell spacer distance 306 between adjacent pairs of solar units. Solar assemblies 300 are, in turn, separated from each other by an optional passageway distance 312. Solar assemblies 300 are installed so that they lie above an albedo surface 316 at a separation distance 314. The separation distance 314 for one solar cell assembly can be the same or different then the separation distance 314 for another solar cell assembly in any given solar cell arrangement.

There are no limitations on the number of cylindrical solar units 1000 that may be used to form a solar cell assembly 300. In some embodiments, a solar assembly 300 comprises 5 or more, 10 or more, 20 or more, 50 or more, 100 or more, 200 or more, or 500 or more cylindrical solar units 1000.

5.2.1.1 Solar Unit Characteristics

In some embodiments, solar cell assemblies 300 comprise solar cell panels and/or peripheral apparatus and systems that support the solar cell panels and maintain solar cell efficiency.

Solar unit dimension 302. Referring to FIGS. 3A through 3C, each cylindrical solar unit 1000 has diameter 302 (regardless of whether the solar unit 1000 is a nonmonolithic solar cell 200 as illustrated in 2A or a monolithically integrated solar module 270 as illustrated in FIG. 2B). In some embodiments, dimension 302 is the diameter of cylindrically shaped solar unit 200. For example, dimension 302 is twice the value of the outer radius (e.g., r₀ of FIG. 2B) of a cylindrical solar unit 1000. For practical manufacturing purposes, dimension 302 of a cylindrical solar unit 1000 is typically between 2 cm and 6 cm. However, there are no limitations on the diameter of cylindrical solar unit 1000. In some embodiments, dimension 302 is 0.5 cm or more, 1 cm or more, 2 cm or more, 5 cm or more, or 10 cm or more.

Spacer distance 306. Adjacent parallel cylindrical solar units 1000 are separated by spacer distance 306. The distance from one edge of a cylindrical solar unit to an adjacent cylindrical solar unit 1000 is distance 304. In some embodiments, distance 304 is the sum of solar unit 1000 dimension 302 and spacer distance 306, as illustrated in FIG. 3B. Similarly, there are no limitations on spacer distance 306. In some embodiments, spacer distance 306 is 0.1 cm or more, 0.5 cm or more, 1 cm or more, 2 cm or more, 5 cm or more, 10 cm or more, or 20 cm or more. In some embodiments, spacer distance 306 is at least equal to or greater than dimension 302 of cylindrical solar units 1000. In some embodiments, spacer distance 306 is 1×, 1.5×, 2×, or 2.5× the dimension 302 of cylindrical solar unit 1000. In some embodiments, spacer distance 306 between each adjacent pair of solar units 1000 in an assembly 300 is the same. In some embodiments, spacer distance 306 between one or more adjacent pairs of solar units 1000 in an assembly 300 is different. In some embodiments, spacer distance 306 between each adjacent pair of solar units 1000 is within a manufacturing threshold. For example, in some embodiments, spacer distance 306 between each adjacent pair of solar units 1000 in an assembly 300 is within ten percent, within five percent, within one percent, or within 0.5 percent of a constant value.

5.2.1.2 Solar Units Assembly Peripheral Characteristics

Installation surface 380. Referring to FIG. 3A, surface 380 on which solar cell assemblies 300 are installed may be broken into two subtypes: covered surface areas and uncovered surface areas. Covered surface areas are in the shadow of cylindrical solar units 1000 and are therefore devoid of direct solar radiation. The cover surface area is proportional to dimension 302 of cylindrical solar units 1000 and reversely proportional to the length of spacer distance 306. Uncovered surface areas are exposed to direct solar radiation. The amount of solar radiation that reaches uncovered surface areas of surface 380 represents the amount of energy that fails to directly contact the surface of cylindrical solar units 1000. One way to enhance solar absorption by solar cell assemblies 300 is to redirect the solar radiation from the uncovered area back towards cylindrical solar units 1000. Referring to FIG. 3C, within the boundary of a solar cell assembly 300, the concepts of covered and uncovered areas may be illustrated by the following example. Suppose cylindrical solar units 1000 have length of l, the sum of spacer distance 306 (d₁) and cell dimension 302 (a₁) is c₁, where c₁=a₁+d₁, and there are n solar units within solar cell assembly 300. When n is sufficiently large and when sunlight directly shines upon solar cell assembly 300, the amount of covered surface on surface 380 is the product of l×a₁×n and the amount of uncovered area is the product of l×d₁×n, assuming that d₁ is uniform. The percentage of surface 380 that is covered may be adjusted by varying the values of a₁ and d₁.

Passageway 312. Adjacent solar cell assemblies 300 are separated from each other by a passageway 312. As illustrated in FIG. 3, two solar cell assemblies 300 are installed above installation surface 380. Solar cell assemblies 300 are coplanar or approximately coplanar. The plane or approximate plane defined by solar cell assemblies 300 is parallel to the plane defined by surface 380. In their coplanar configuration, as illustrated in FIG. 3C, adjacent solar cell assemblies 300 are arranged next to each other such that the cylindrical axes of solar units are parallel to each other. In some embodiments, a straight line (e.g., 305 in FIG. 3C) may be drawn along the ends of solar units 1000 of two adjacent solar cell assemblies 300. The space that separates the adjacent side-by-side solar cell assemblies 300 is passageway 312, as shown in FIGS. 3B and 3C. The dimensions of passageway 312 also contribute to the efficiency of the solar cell assemblies 300. In some embodiments, similar to spacer distance 306, the presence of passageway 312 increases the efficiency of solar cell assembly 300. In some embodiments, passageway 312 is equal to or less than distance 314 of FIG. 3B.

Albedo layer 316. In some embodiments, high albedo material (e.g., white paint) is deposited on surface 380 on which solar cell assemblies 300 are installed, thus creating an albedo layer 316. In some embodiments, as illustrated in FIGS. 3A through 3C, albedo layer 316 is parallel to the planed defined by solar cell assemblies 300. Albedo is a measure of reflectivity of a surface or body. It is the ratio of electromagnetic radiation (EM radiation) reflected to the amount incident upon it. This fraction is usually expressed as a percentage from zero to one hundred. The purpose of implementing albedo layer 316 is to redirect the solar radiation that hits the uncovered surface areas back towards the cylindrical solar units 1000 of assemblies 300.

In some embodiments, surfaces in the vicinity of the solar cell assemblies of the present invention are prepared so that they have a high albedo by painting such surfaces a reflective white color. In some embodiments, other materials that have a high albedo can be used. For example, the albedo of some materials around such solar units approach or exceed seventy, eighty, or ninety percent. See, for example, Boer, 1977, Solar Energy 19, 525, which is hereby incorporated by reference herein in its entirety. However, surfaces having any amount of albedo (e.g., fifty percent or more, sixty percent or more, seventy percent or more) are within the scope of the present invention. In one embodiment, the solar cells assemblies of the present invention are arranged in rows above a gravel surface, where the gravel has been painted white in order to improve the reflective properties of the gravel. In general, any Lambertian or diffuse reflector surface can be used to provide a high albedo surface. More description of albedo surfaces that can be used in conjunction with the present invention are disclosed in U.S. patent application Ser. No. 11/315,523, which is hereby incorporated by reference herein in its entirety. In some embodiments, a self-cleaning layer is coated over albedo surface 316. More description of such self-cleaning layers is described in U.S. patent application Ser. No. 11/315,523, which is hereby incorporated by reference herein in its entirety.

Separation distance 314. Referring to FIGS. 3A through 3C, in some embodiments, solar units 1000 are installed at least a separation distance 314 above installation surface 380. This means that the closest point between (i) any portion of any solar unit 1000 in an assembly and installation surface is at least some finite separation distance 314. Separation distance 314 is greater than zero. In some embodiments, solar units 1000 are installed at an angle relative to installation surface. In such embodiments, a large portion of each solar unit 1000 is at a distance away from installation surface 380 that is much greater than the minimum separation distance 314. However, in such embodiments, all portions of each solar unit 1000 is at distance away from installation surface 380 that is equal to or greater than separation distance 314. In some embodiments, all or a portion of some of the solar units 1000 in a solar cell assembly are less than the minimum separation distance 314. However, such embodiments are not preferred.

In some embodiments, installation surface 380 is deposited with high albedo material (e.g., white paint) to form a high albedo surface 316. In some embodiments, separation distance 314 is greater than the length of spacer distance 306. In some embodiments, separation distance 314 is greater than the width of passageway 312. In some embodiments, separation distance 314 is greater than the length of spacer distance 306 and separation distance 314 is greater than the width of passageway 312. In some embodiments, the plane or approximate plane defined by solar cell assemblies 300 is twenty-five centimeters or more off high albedo surface 316 (e.g., distance 314 is twenty-five centimeters or more) and/or installation surface 380. In some embodiments, for example, the plane defined by solar cell assemblies 300 is two meters or more off surface 316. In some embodiments, the plane defined by solar cell assemblies 300 is at an angle relative to installation surface 380. In some embodiments, high albedo surface 316 is the roof of a multistory building, the roof of a large manufacturing or the roof of an entertainment facility. In some embodiments, there are pipes or other objects between high albedo surface 316 and the plane defined by solar cell assemblies 300. In such embodiments, such obstructing objects may themselves be coated with albedo material in order to produce an albedo environment below the plane defined by solar cell assemblies 300.

Additional characterization of solar cell assemblies is possible. See, for example, Durisch et al., 1997, “Characterization of a large area photovoltaic laminate,” Bulletin SEV/VSE 10: 35-38; Durisch et al., 2000, “Characterization of photovoltaic generators,” Applied Energy 65: 273-284; and Durisch et al., 1996, “Characterization of Solar Cells and Modules under Actual Operating Conditions,” Proceedings of the World Renewable Energy Congress 1: 359-366; each of which is hereby incorporated herein by reference in its entirety.

5.2.2 Encased Spacer-Separated Solar Cell Assemblies

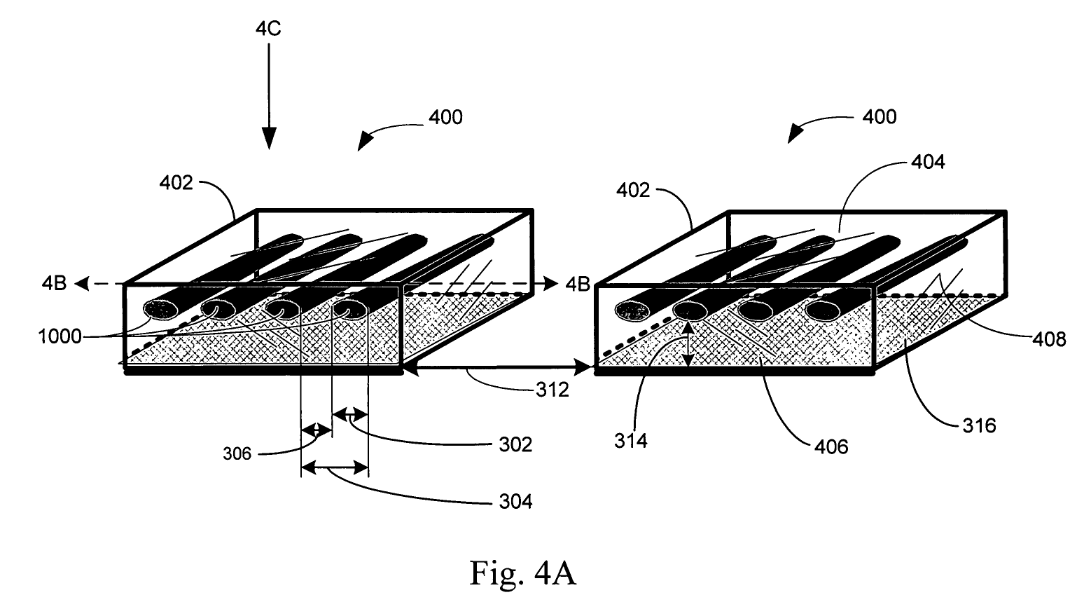

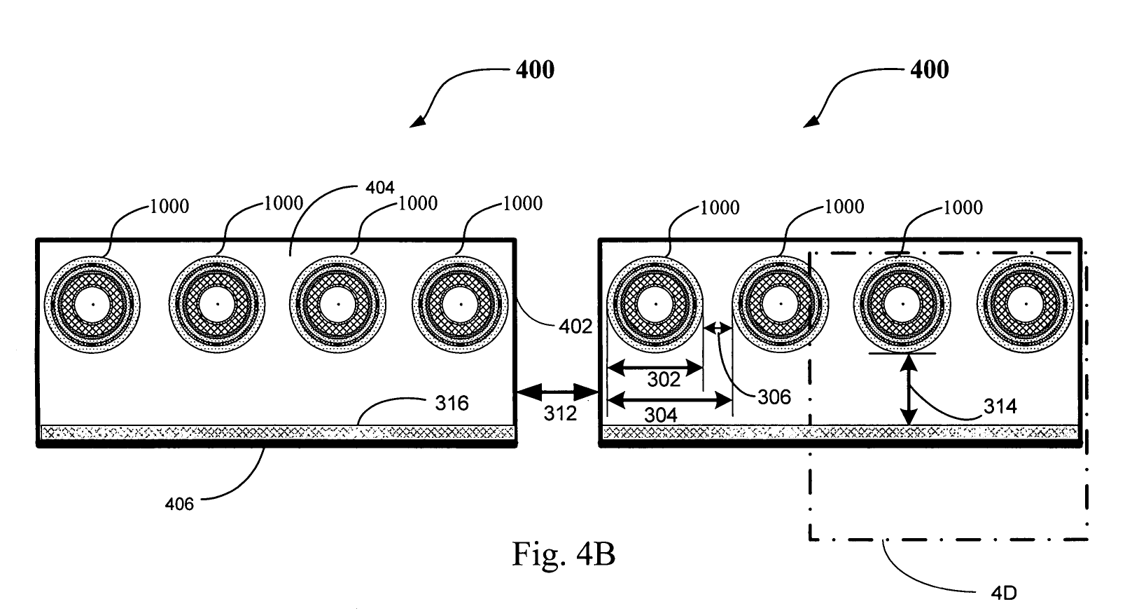

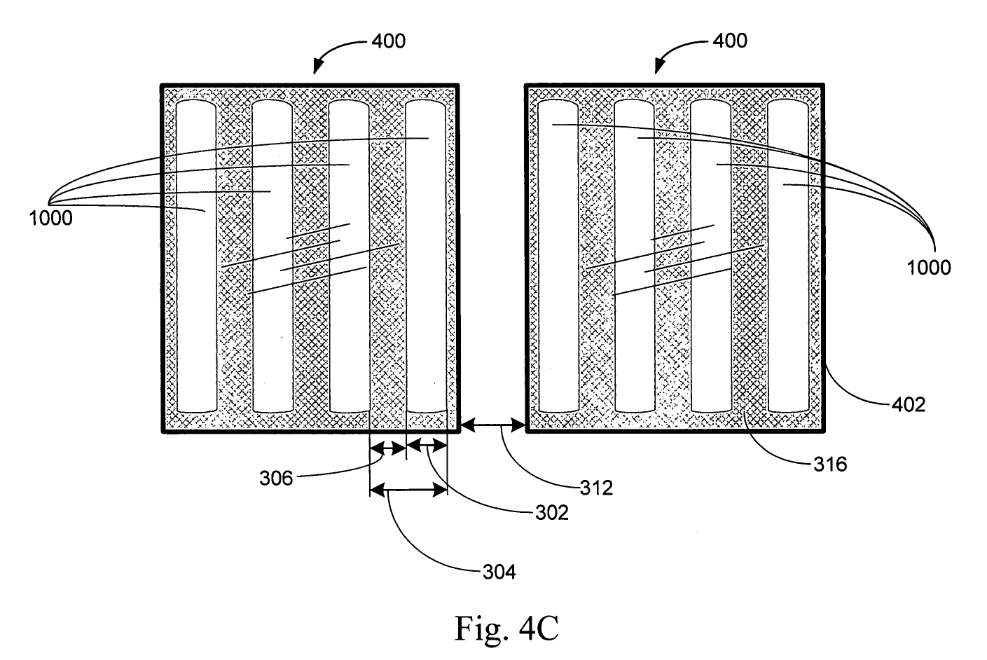

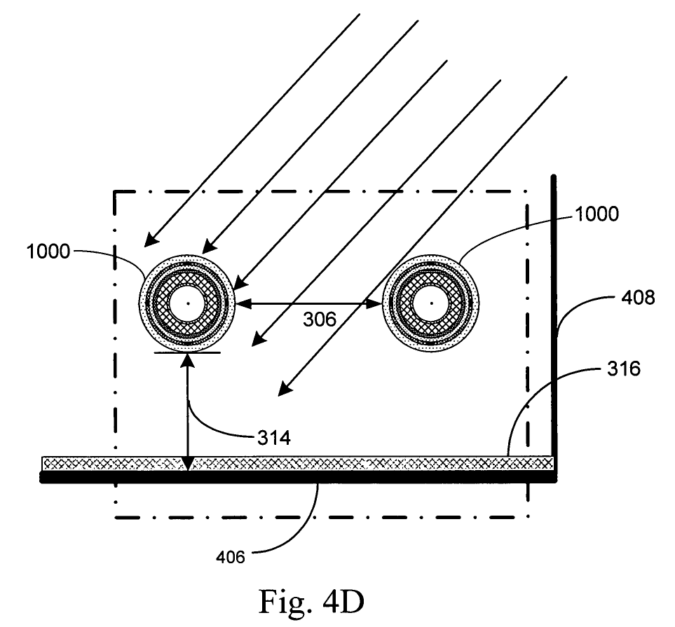

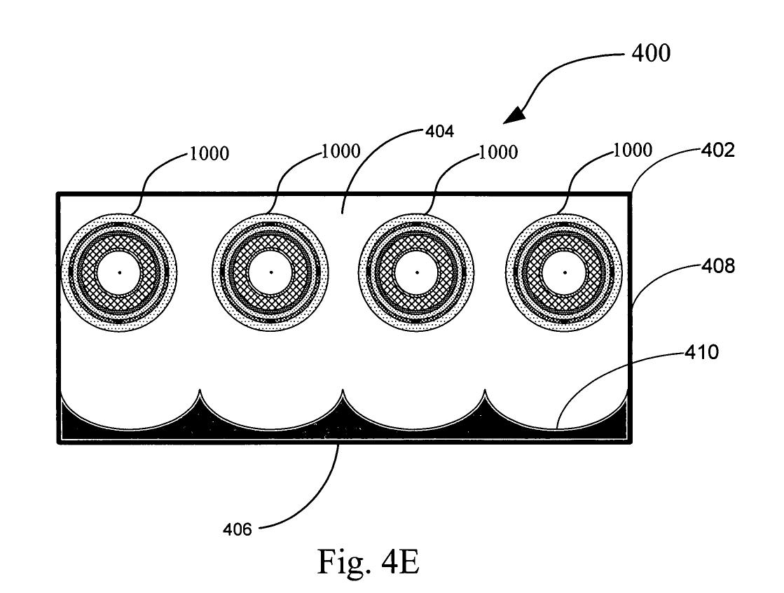

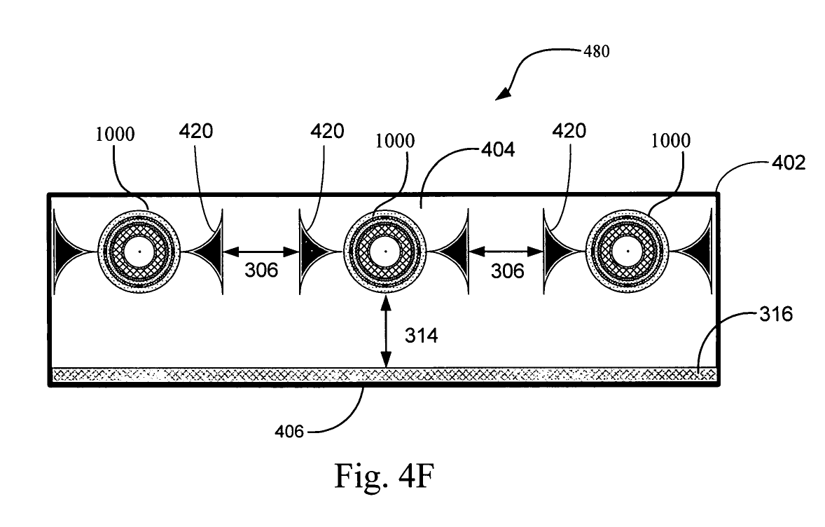

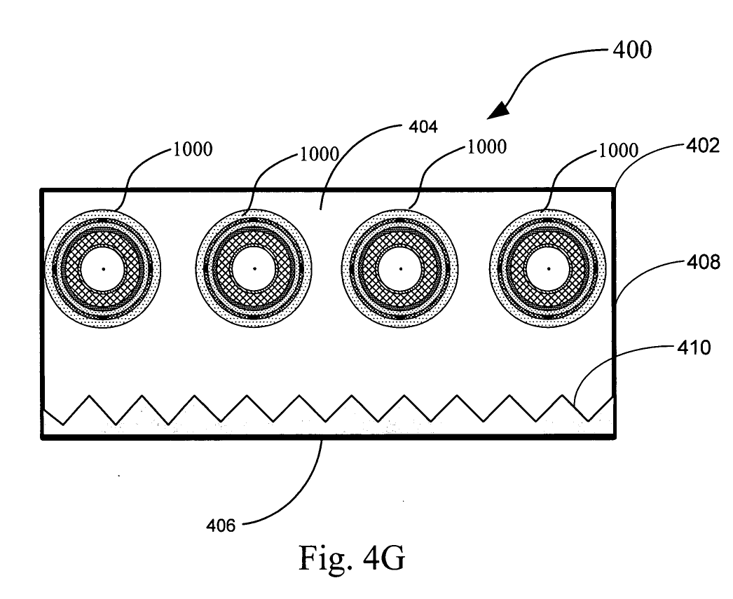

Casing 402. Referring to FIG. 4A, in some embodiments, solar units 1000 are encased, for example, by box-like casing 402 to form solar cell assembly 400. Referring to FIGS. 4A through 4C, casing 402 comprises an optional top layer 404, a bottom 406 and a plurality of transparent side panels 408. Although not shown, casing 402 can have beveled corners and can, in fact, have any three dimensionally form. In some embodiments, top surface 404 is a transparent layer that seals solar units 1000 in the solar cell assembly. In some embodiments, there is no transparent layer on top surface 404, and cylindrical solar units 1000 are exposed to direct solar radiation.

In some embodiments, when the optional top surface 404 is present in the encased solar cell assembly 400, the top surface 404 may be modified to facilitate solar absorption by cylindrical solar units 1000. In some embodiments, top surface 404 is a glass layer, preferably made of low ion glass to reduce absorption of solar radiation. In some embodiments, top surface 404 is a textured glass surface. Patterns may be created on the glass surface to eliminate any glaring effects. In some embodiments, top surface 404 is made of polymer material, preferably material that is stable in UV radiation. In some embodiments, other suitable transparent material may also be used to form top surface 404. In some embodiments, top surface 404 is coated with anti-reflective coating on one side.

Similar to top surface 404, in some embodiments, side panels 408 are transparent and can be made of, for example plastic or glass to reduce or eliminate shadow effects on cylindrical solar units 1000. In some embodiments, optional top cover layer 404 is also made of transparent plastic or glass materials. In such embodiments, transparent cover layer 404 and transparent side panels 408 seal cylindrical solar units 1000 from dirt and debris. Advantageously, encased solar cell assemblies 400 with a sealed top surface 404 are easier to clean, maintain, and transport. Side panels 408 can be made out of any of the materials used to make top surface 404. Furthermore, side panels 408 can be coated with an anti-reflective coating.

Transparent top cover layer 404 and transparent side panels 408 may be composed of the same materials used to make transparent tubular casing 210. In some embodiments, transparent top cover layer 404 and transparent side panels 408 are made of aluminosilicate glass, borosilicate glass, dichroic glass, germanium/semiconductor glass, glass ceramic, silicate/fused silica glass, soda lime glass, quartz glass, chalcogenide/sulphide glass, fluoride glass, flint glass, or cerated glass. In some embodiments, transparent top cover layer 404 and/or side panels 408 are made of a urethane polymer, an acrylic polymer, a fluoropolymer, a silicone, a silicone gel, an epoxy, a polyamide, or a polyolefin.

In some embodiments, transparent top cover layer 404 and/or transparent side panels 408 are made of a urethane polymer, an acrylic polymer, polymethylmethacrylate (PMMA), a fluoropolymer, poly-dimethyl siloxane (PDMS), ethyl vinyl acetate (EVA), perfluoroalkoxy fluorocarbon (PFA), nylon/polyamide, cross-linked polyethylene (PEX), polyolefin, polypropylene (PP), polyethylene terephtalate glycol (PETG), polytetrafluoroethylene (PTFE), thermoplastic copolymer (for example, ETFE® which is a derived from the polymerization of ethylene and tetrafluoroethylene: TEFLON® monomers), polyurethane/urethane, transparent polyvinyl chloride (PVC), polyvinylidene fluoride (PVDF), Tygon®, vinyl, Viton®, or any combination or variation thereof.

In some embodiments, transparent top cover layer 404 and/or transparent side panels 408 comprise a plurality of transparent casing layers. For example, in some embodiments, transparent top cover layer 404 and/or transparent side panels 408 are coated with an antireflective coating layer and/or a water resistant layer. In some embodiments, transparent top cover layer 404 and/or transparent side panels 408 have excellent UV shielding properties. Moreover, the use of multiple transparent top cover layers 404 and transparent side panels 408 can reduce costs and/or improve the overall properties of transparent top cover layer 404 and transparent side panels 408. For example, one layer of top cover layer 404 and/or transparent side panels 408 may be made of an expensive material that has a desired physical property. By using one or more additional layers, the thickness of the expensive layer may be reduced, thereby achieving a savings in material costs. In another example, one transparent layer of top cover layer 404 and/or transparent side panels 408 has a desired optical property (e.g., index of refraction, etc.) but may be very dense. By using one or more additional transparent layers, the thickness of the dense layer may be reduced, thereby reducing the overall weight of the transparent top cover layer 404 and/or transparent side panels 408. Additional materials for making transparent cover layer 404 and transparent side panels 408 are described in co-pending U.S. patent application Ser. No. to be determined, attorney docket number 11653-008-999, entitled “Elongated Photovoltaic Cells in Tubular Casings,” filed Mar. 18, 2006, which is hereby incorporated herein by reference in its entirety.

The presence of top cover layer 404, however, may also prevent the heat generated by solar radiation from being released from the encased solar cell assembly 400. In some embodiments, openings are formed in transparent side panels 408, bottom surface 406, or even top surface 404 to enhance air circulation between solar cell assembly 400 and the outside environment. In some embodiments, the openings may be small holes with diameters of 1 mm or larger, 2 mm or larger, 5 mm or larger. In some embodiments, these holes are covered with meshing to prevent debris from entering assemblies 400. In some embodiments, such meshing is made of transparent plastic.

Within a solar cell assembly 400, cylindrical solar units 1000 are also defined by dimension 302 and are separated from each by a spacer distance 306. Also as in the case of solar cell assemblies 300, in some embodiments, a distance 304 is defined as the sum of spacer distance 306 and dimension 302. Optional top cover layer 404, transparent side panels 408, and bottom surface 406 collectively affect air circulation surrounding cylindrical solar units 1000. In some embodiments, optional top cover layer 404 is absent from solar cell assembly 400. In such embodiments, heat generated from solar radiation is more efficiently released from solar cell assemblies 400. In some embodiments, especially when optional top cover layer 404 is absent, drainage system (e.g., one or more holes in bottom surface 406) may be implemented into solar cell assemblies 400 to drain precipitation.

Within each encased solar cell assembly, cylindrical solar units 1000 are positioned at a distance 314 from bottom 406. Referring to FIG. 4D, cylindrical solar units 1000 are separated by spacer distance 306 to reduce or eliminate the shadowing effect from neighboring cylindrical solar units 1000.

In some embodiments, direct sunlight passes through spacer distance 306 and hits bottom surface 406 and/or layer 316. Bottom surface 406 is different from transparent side panels 408 or optional top surface 404 in the sense that there is no requirement that bottom surface 406 be transparent. Rather, bottom surface 406 is highly reflective in some embodiments. In some embodiments, bottom surface 406 is able to reflect solar radiation (in contrast to the solar energy that is absorbed by cylindrical solar units 1000) back onto cylindrical solar units 1000 in order to enhance solar radiation absorption by the cylindrical solar units. In some embodiments, bottom surface 406 is a specular surface that reflects solar radiation back onto cylindrical solar units 1000 in order to enhance solar radiation absorption. In some embodiments, a high albedo layer 316 is deposited on the surface of bottom 406 in order to reflect solar radiation onto solar units 1000. A more detailed discussion on the reflective properties of bottom surface 406 and installation surface 380 is provided in Section 5.2.3, below. In some embodiments, albedo surface 316 is parallel to the planar surface defined by cylindrical solar units 1000 in solar cell assembly 400. Albedo surface 316 and the planar surface defined by cylindrical solar units 1000 are separated from each other by distance of 314. Furthermore, in some embodiments, encased solar cell assemblies 400 are separated from each other by passageway 312.

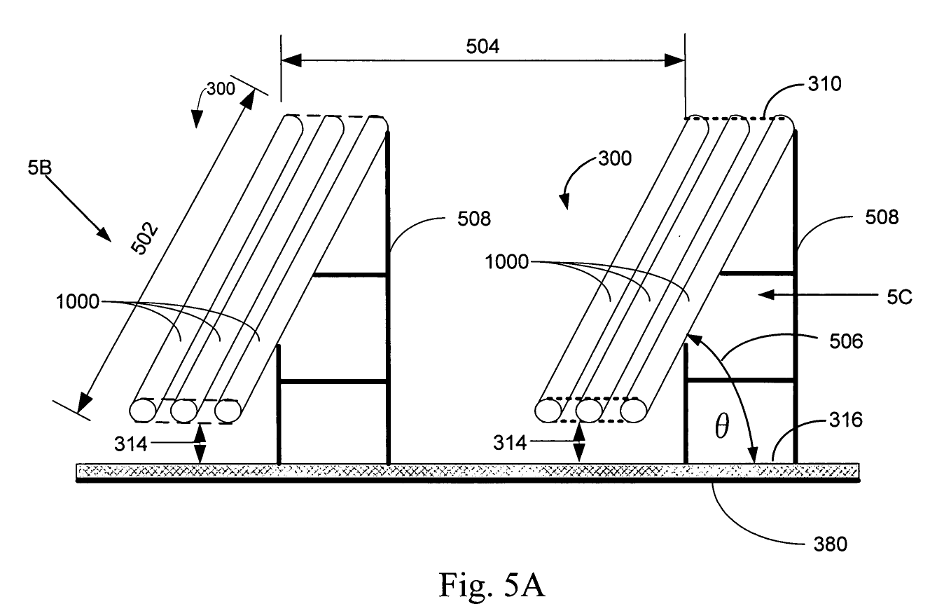

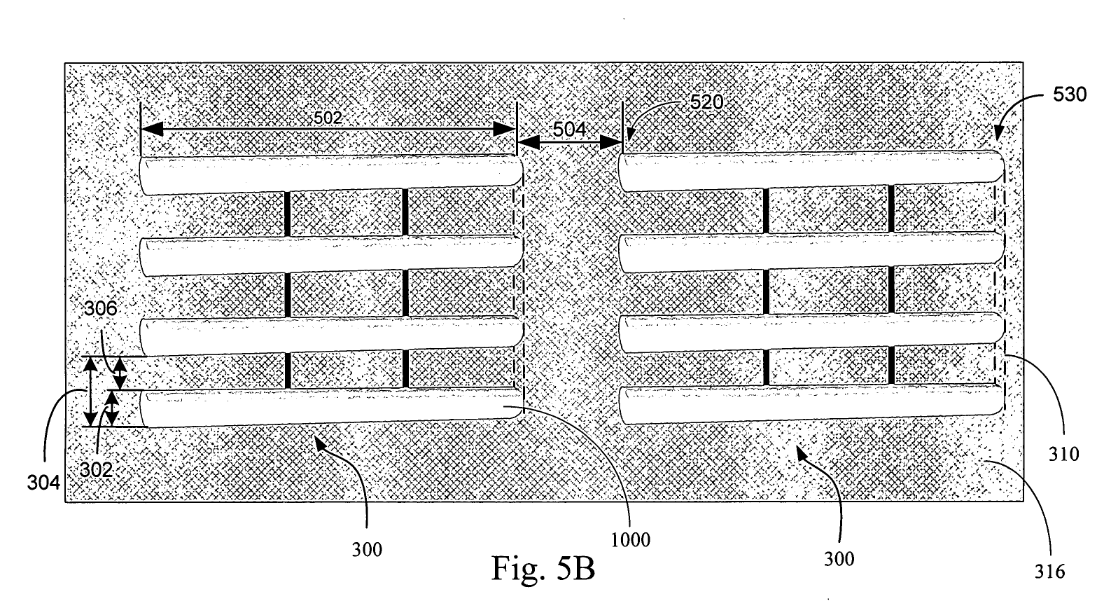

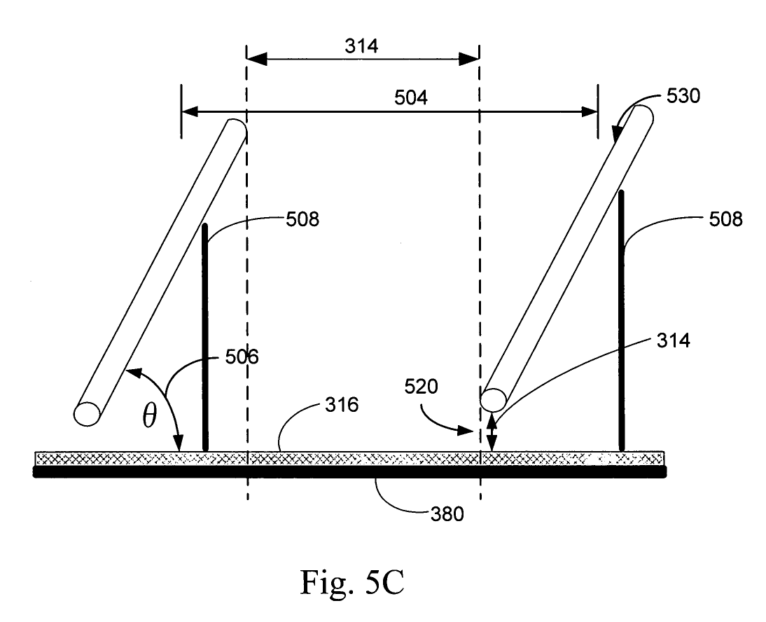

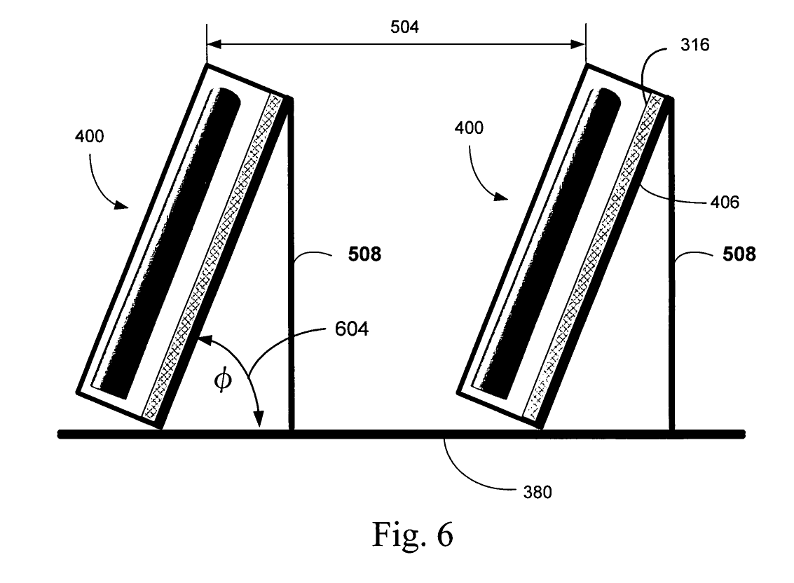

In some embodiments, solar cell assemblies 480, as illustrated in FIG. 4F, are installed parallel to bottom 406. In the parallel configuration, precipitation may collect between cylindrical solar units 1000. In some embodiments, cylindrical solar units 1000 are installed such that the cylindrical axis of the units is at an angle relative to bottom 308, as illustrated in FIGS. 5A and 6A, to facilitate solar cell assembly 480 water drainage. In some embodiments, casing 402 is absent from the final solar cell assembly. For example, cylindrical solar units 1000 and involute internal reflectors 420 are directly assembled to connection device 310.

5.2.3 Concentrators and Reflectors

In some embodiments, bottom surface 406 (FIG. 4) and/or installation surface 380 is engineered so that solar radiation is more effectively reflected towards cylindrical solar units 1000. In some embodiments, concentrators (e.g., concentrators 410 in FIG. 4E) and/or a reflective surface can be engineered into bottom surface 406 and/or installation surface 380 to direct solar radiation back towards solar units 1000 and improve the performance of the solar cell assemblies of the present invention. The use of a static concentrator in one exemplary embodiment is illustrated in FIG. 4E, where static concentrator 410 is placed on bottom surface 406 to increase the efficiency of the solar cell assembly. Static concentrator 410 may be used with solar cell assembly 300 (e.g., as depicted in FIG. 3), encased solar cell assembly 400 (e.g., as depicted in FIG. 4), or any additional embodiments in accordance with the present invention. When reflective devices such as static concentrator 410 are used with a solar cell assembly (e.g., solar cell assembly 300 in FIG. 3) where the box-like casing is absent, static concentrators 410 may be placed over installation surface 380.

Static concentrator 410 can be formed from any static concentrator materials known in the art such as, for example, a simple, properly bent or molded aluminum sheet, or reflector film on polyurethane. The shape of reflectors 410 are designed to reflect solar radiation towards cylindrical solar units 1000. In some embodiments, reflectors are parabolic trough-like reflectors as illustrated in FIG. 4E. In some embodiments, concentrator 410 is a low concentration ratio, nonimaging, compound parabolic concentrator (CPC)-type collector. That is, any (CPC)-type collector can be used with the solar cell assemblies of the present invention. For more information on (CPC)-type collectors, see Pereira and Gordon, 1989, Journal of Solar Energy Engineering, 111, pp. 111-116, which is hereby incorporated herein by reference in its entirety.

In some embodiments, a static concentrator 410 as illustrated in FIG. 4G is used. Again, static concentrator 410 may be used with solar cell assembly 300 (e.g., as illustrated in FIG. 3), encased solar cell assembly 400 (e.g., as illustrated in FIG. 4), or any additional embodiments in accordance with the present invention. Static concentrator 410 in FIG. 4G comprises submillimeter v-grooves that are designed to capture and reflect incident light towards solar units 1000. More details of such concentrators may be found in Uematsu et al., 2001, Solar Energy Materials & Solar Cell 67, 425-434 and Uematsu et al., 2001, Solar Energy Materials & Solar Cell 67, 441-448, each of which is hereby incorporated herein by reference in its entirety.

In some embodiments, the concentrator used in the present invention is any type of concentrator, such as those discussed in Handbook of Photovoltaic Science and Engineering, 2003, Luque and Hegedus (eds.), Wiley & Sons, West Sussex, England, Chapter 11, which is hereby incorporated by reference herein in its entirety. Such concentrators include, but are not limited to, parabolic concentrators, compound parabolic concentrators, V-trough concentrators, refractive lenses, the use of concentrators with secondary optical elements (e.g., v-troughs, refractive CPCs, refractive silos, etc.), static concentrators (e.g., dielectric prisms that rely on total internal reflection), RXI concentrators, dielectric-single mirror two stage (D-SMTS) trough concentrators, and the like. Additional concentrators are found in Luque, Solar Cells and Optics for Photovoltaic Concentration, Adam Hilger, Bristol, Philadelphia (1989), which is hereby incorporated herein by reference in its entirety. In some embodiments, a simple reflective surface is used.

Still additional concentrators that can be used with the present invention are disclosed in Uematsu et al., 1999, Proceedings of the 11th International Photovoltaic Science and Engineering Conference, Sapporo, Japan, pp. 957-958; Uematsu et al., 1998, Proceedings of the Second World Conference on Photovoltaic Solar Energy Conversion, Vienna, Austria, pp. 1570-1573; Warabisako et al., 1998, Proceedings of the Second World Conference on Photovoltaic Solar Energy Conversion, Vienna, Austria, pp. 1226-1231; Eames et al., 1998, Proceedings of the Second World Conference on Photovoltaic Solar Energy Conversion, Vienna Austria, pp. 2206-2209; Bowden et al., 1993, Proceedings of the 23rd IEEE Photovoltaic Specialists Conference, pp. 1068-1072; and Parada et al., 1991, Proceedings of the 10th EC Photovoltaic Solar Energy Conference, pp. 975-978, each of which is hereby incorporated by reference herein in its entirety.

In some embodiments, internal reflectors are added in between solar units 1000 to enhance absorption of solar radiation. As used herein, the term internal reflector refers to any type of reflective device that lies between solar units 1000 and is generally in the same plane as solar units 1000 in an assembly of solar units. Internal reflectors have the general property of increasing the exposure of an adjacent solar unit 1000 to solar radiation. However, internal reflectors do, to some extent, obviate one of the primary benefits of the present invention, reduced shadowing effects. Accordingly, in some embodiments, internal reflectors are not used. In some embodiments, internal reflectors are used but are designed to minimize shadowing.

For example, referring to FIG. 4F, involute internal reflectors 420 are attached at either side of cylindrical solar units 1000 to direct solar radiation towards the solar units. The shape of each involute reflector complements the shape of a corresponding cylindrical solar unit 1000. Involute internal reflectors 420 on adjacent cylindrical solar units 1000 are separated by spacer distance 306. In some embodiments, as illustrated in FIG. 4F, the assembled array of cylindrical solar unit 1000 and involute reflectors 420 (e.g., solar cell assembly 480 in FIG. 4F) are at a distance 314 from surface 406 and/or installation surface 380. In some embodiments, a high albedo layer 316 is deposited on surface 406 and/or installation surface 380. In some embodiments bottom 406 and/or installation surface 380 is made of an albedo material. In such embodiments, albedo layer 316 is not required.

Reflective material may be deposited on reflective surfaces 380, 406, 410 and/or 420 using, for example, vacuum deposition techniques. In some embodiments, a roll coating process is developed to coat a first reflective coating (for example, a surface silver mirror) on reflective surfaces 380, 406, 410 and/or 420 with a protective alumina coating. In some embodiments, the reflective layer is coated over a metal layer that is deposited on a substrate surface (e.g., on reflective surfaces 380, 406, 410 and/or 420) by a vacuum evaporation process. In some embodiments, the protective alumina coating is deposited by ion beam assisted deposition.

In some embodiments, the thickness of the reflective coating on reflective surfaces 380, 406, 410 and/or 420 is more than 0.5 microns, 1 micron or more, 2 microns or more, or 5 microns or more. In some embodiments, specular reflectance above 90 percent can be maintained for at least 10 years on reflective surfaces 380, 406, 410 and/or 420.

5.2.4 Installation of Solar Cell Assemblies

Solar cell assemblies with or without casing (e.g., solar cell assembly 300 in FIGS. 3 and 5 or solar cell assemblies 400 in FIGS. 5 and 6) may be either installed parallel to an installation surface 380 and/or bottom 406 or at a tilt angle to an installation surface 380 and/or bottom 406. For example, referring to FIG. 5A, solar cell assemblies 300 may be installed with a tilt angle (e.g., θ or 506 in FIG. 5A). Tilt angle 506 is the angle between the planar surface which is formed by the cylindrical axes of the solar units within a solar cell assembly 300 and the surface on which the solar cell assemblies are installed. In some embodiments, as illustrated in FIG. 5C, tilt angle 506 is the angle between the planar surface of solar cell assemblies 300 and albedo coated surface 316. Tilt angles 506 may be adjusted to maximize the exposure of cylindrical solar units 1000 to solar radiation. In some embodiments, tilt angles 506 change with respect to the geographic location of the solar cell assemblies. For example, tilt angle 506 of a solar cell assembly 300 may be close to zero if the solar cell assembly is installed near the equator, but tilt angle 506 of a solar cell assembly 300 installed in Sacramento, Calif. may be much larger than zero. In some embodiments, tilt angle 506 may be between 0 and 2 degrees, between 2 and 5 degrees, 2 degrees or more, 10 degrees or more, 20 degrees or more, 30 degrees or more, or 50 degrees or more.

Incident angle of solar radiation changes daily. The seasonal variation of solar radiation may be taken advantage of to maximize solar radiation absorption by solar cell assemblies (e.g., solar cell assemblies 300 or 400). In some embodiments, tilt angle 506 of installed solar cell assemblies may be seasonally adjusted.

Installation of solar cell assemblies 300 at a tilt angle 506 may be achieved by using support 508 (e.g., frame-like support as shown in FIG. 5A). In some embodiments, frame-like support may have a simple built-in mechanism to allow the solar cell assemblies (e.g., solar cell assemblies 300 in FIG. 5 or solar cell assemblies 400 in FIG. 6) to be installed at more than one tilt angle. For example, frame-like support 506 may have one or more settings (e.g., one of more build-in grooves) to which solar cell connection device 310 may be connected.

In some embodiments, as illustrated in FIG. 5C, separation distance 314 between solar cell assemblies 300 and albedo surface 316 is the minimum distance between any portion of a solar unit 1000 and the albedo surface 316.

In some embodiments, encased solar cell assemblies 400 may also be installed at a tilt angle. The tilt for solar assemblies is different from tilt angle 504 (depicted in FIG. 5). The tilt angle for solar cell assemblies 400 is the angle between the planar surface of solar cell assembly 400 and installation surface 380. In some embodiments of encased solar cell assemblies 400, a high albedo layer 316 is deposited on bottom surface 406 of casing 402. In these embodiments, the distance between the solar units and bottom albedo layer 316 is approximately the same along the cylindrical axis of each cylindrical solar unit 1000. The tilt angle for solar cell assemblies 400, therefore, does not impact how transmitted solar radiation is reflected back to solar units 1000. However, the tilt angle for solar cell assemblies 400 affects how heat generated from absorbed solar radiation is released from solar cell assembly 400. In general, a larger tilt angle for solar cell assemblies 400 more effectively facilitates heat release from solar cell assembly 400. When solar cell assemblies 400 are installed on roof tops, solar radiation absorption by the solar units often generate large amounts of heat, which in turn heats up the roof tops considerably. For example, when solar cell assemblies 400 are installed at a tilt angle 604, as illustrated in FIG. 6, the empty space between the back of solar cell assemblies 400 and support frames 508 permits fluid air circulation to effectively cool down cylindrical solar cells 200. At lower temperatures, cylindrical solar units 1000 radiate less heat towards the roof tops.

FIG. 5B illustrates the relative position of two solar cell assemblies 300 that are arranged in a front-and-back configuration. The front-and-back configuration differs from the side-by-side configuration of FIG. 4C. As depicted in FIGS. 5A through 5C, adjacent solar cell assemblies in the front-and-back configuration are arranged in a line. The adjacent solar units in the front-and-back configuration are separated from each other by distance 504. Distance 504 changes with tilt angle 506. When tilt angle 506 becomes zero (i.e., solar cell assembly 300 is parallel to installation surface 380 and high albedo surface 316), adjacent cylindrical solar units 1000 may be arranged end to end (e.g., 504 is zero) to achieve maximum coverage of installation surface 380. Maximum coverage of installation surface 380 may also be achieved by reducing spacer distance 306 to zero, i.e., by arranging cylindrical solar units right next to each other.

### 5.3 Advantages of Solar Cell Assemblies

Advantageously, solar cell assemblies 300 and 400, formed by spatially separated solar units 1000, are more efficient at absorbing incoming solar radiation, more resistant to adverse weather conditions, and create less negative impact on their surrounding (e.g., over heating of mounting surfaces such as the roof of a building).

Increase collection efficiency by minimizing shadowing effect. The shadowing effects from adjacent cylindrical solar units 1000 depends on the position of solar radiation that hits the surface. For example, when solar radiation hits the top of cylindrical solar units 1000 at a perfect perpendicular angle (e.g., as shown in FIG. 3D when the angle of incidence is zero), there is no shadowing effect from adjacent solar cells. In fact, at this solar radiation position, half of the surface of each cylindrical solar unit 1000 is exposed to direct sunlight. Such direct solar radiation, however, occurs only for a very limited amount of time during the day, for example, only around noon. Most of the time during the day, solar radiation contacts cylindrical solar units 1000 at an angle that is not perpendicular to the top of the cylindrical solar unit 1000. Under these situations, for a given cylindrical solar unit 1000, a portion of the incoming solar radiation will be blocked off by a neighboring cylindrical solar unit 100 when adjacent units 1000 are positioned too closely next to each other. Effectively, the photovoltaic surface in the shadow created by neighboring solar unit 1000 is devoid of direct solar radiation. As a result, absorption of solar radiation is attenuated.

Advantageously, the presence of spacer distance 306 permits maximum exposure of cylindrical solar units 1000 to solar radiation and thus increases its efficiency through enhanced solar absorption. Referring to FIG. 3E, two cylindrical solar units 1000 are separated by spacer distance 306. At any given angle of incoming solar radiation, the shadowing effect is determined by spacer distance 306. As the angles of incidence with respect to the plane defined by solar units 1000 gets larger, adjacent cylindrical solar units 1000 cast larger shadow area on the neighboring solar units 1000. By spacing out cylindrical solar units 1000, as depicted in FIG. 3E, the shallow area is reduced. In some embodiments, when spacer distance 306 is adjusted such that the shadowing effects from adjacent cylindrical solar units 1000 are minimized for substantial portions of the day.

Also advantageously, the presence of spacer distance 306 permits the solar units 1000 to be exposed to solar radiation longer so that the solar cell assemblies in accordance with the present invention maintain high efficiency until 4 or 5 o'clock in the afternoon or even early evening. In order to fully utilize solar electricity energy, photovoltaic peak efficiency needs to compete with peak electricity load. Peak electricity load depends on the geographic location, regional industry, and population distribution. For example, in Arizona on a hot summer day, peak electricity load may occur when most people turn on their air conditioning at home or at work. Under some situations, peak electricity load occurs in early evening when most people returns to their household. However, there is no sunlight at night. For most conventional solar cell systems, the photovoltaic efficiency peaks emerge around noon when maximum amount of solar radiation is directly cast on the solar units 1000. The peak electricity load in early evenings thus relies on electricity generation by natural gas or other resources. Collection efficiency may be calculated using the method proposed by Durisch et al. in “Efficiency of Selected Photovoltaic Modules and Annual Yield at a Sunny Site in Jordan,” Proceedings of the World Renewable Energy Congress VIII (WREC 2004): 1-10, which is hereby incorporated herein by reference in its entirety.

Increased collection efficiency by decreasing heating of the cylindrical solar units. As solar units 1000 in solar cell assemblies (e.g., solar cell assembly 300 in FIGS. 3 and 5 or solar cell assemblies 400 in FIGS. 4 and 6) absorb solar radiation, their temperature rises. The electricity conversion efficiency of most solar units 1000 is adversely affected by increase in temperature of the solar cell panel. The high temperature-related reduction in efficiency is observed in most solar cell systems, for example, the efficiency of solar cell systems with semiconductor system based on CIGS and crystalline silicon may drop about 0.5 percent with each degree increase in temperature of the solar cell assembly. Additional information on solar cell performance and efficiency can be found in Burgess and Pritchard, 1978, “Performance of a One Kilowatt Concentrator Photovoltaic Array Utilizing Active Cooling,” IEEE photovoltaic specialists conference, Washington, DCCONF-780619-5 and Yoshida et al., 1981, “High efficiency large area AlGaAs/GaAs concentrator solar cells,” Photovoltaic Solar Energy Conference, Proceedings of the Third International Conference A82-24101 10-44: 970-974, each of which is hereby incorporated herein by reference in its entirety.

Advantageously, the presence of spacer distance 306, passageway 312 and height 314 promote air circulation within solar cell assemblies 300. In some embodiments, effective cooling of the solar units 1000 is achieved when height 314 is larger than at least spacer distance 306 or passageway 312. FIG. 3F illustrate a possible mechanism by which spacer distance 306, passageway 312 and height 314 facilitate cooling of the heated solar cell assemblies. Because of the presence of spacer distance 306, passageway 312 and separation distance 314, air surrounding the cylindrical solar units 1000 is in fluid communication with ambient air. Heat from cylindrical solar units 1000 is released in many air streams, for example, in air flow 320, 330 and 340 as illustrated in FIG. 3F. Moreover, natural convection current such as wind further facilitate heat release from the heated cylindrical solar units 1000. General references on national convection flow and heat transfer include Lin and Churchill, 1978, “Turbulent Free Convection From a Vertical Isothermal Plate,” Numerical Heat Transfer 1: 129-145; Siebers et al., 1985, “Experimental, Variable Properties Natural Convection From a Large, Vertical, Flat Surface,” ASME J. Heat Transfer 107: 124-132; and Warner and Arpaci, 1968, “An Experimental Investigation of Turbulent Natural Convection in Air along a Vertical Heated Flat Plate,” Intl. J. Heat & Mass Transfer 11: 397-406; each of which is hereby incorporated herein by reference in its entirety. More specific references related to solar cell systems include M. J. O'Neill, “Silicon Low-Concentration, Line-Focus, Terrestrial Modules,” Chapter 10 in Solar Cells and their Applications, John Wiley & Sons, New York, 1995; and Sandberg and Moshfegh, 2002, “Buoyancy-Induced Air Flow In Photovoltaic Facades—Effect Of Geometry of the Air Gap and Location of Solar Cell Modules,” Building and Environment 37: 211-218(8); each of which is hereby incorporated herein by reference in its entirety.

Better structural integrity due to reduced wind load effect. Structural integrity of solar cell panels is important for device lifetime. Strong wind, though helpful in reducing the temperature of solar units 1000, may often cause structural damages to solar cell panels. Advantageously, solar cell assemblies disclosed in the present invention (e.g., solar cell assembly 300) are formed by spatially separated solar units 1000. Therefore, they are more resistant to adverse weather conditions, for example, snow or rain storms with strong wind. As illustrated in FIG. 3F, the presence of spacer distance 306, height 314 and passageway 312 effectively reduce the overall wind load of solar cell assembly 300. For additional references on wind load and reliability and performance of photovoltaic module, see, for example, Munzer et al., 1999, “Thin monocrystalline silicon solar cells,” IEEE Transactions on Electron Devices 46 (10): 2055-2061; Hirasawa et al., 1994, “Design and drawing support system for photovoltaic array structure,” Photovoltaic Energy Conversion, Conference Record of the Twenty Fourth IEEE Photovoltaic Specialists Conference 1: 1127-1130; Dhere et al., “Investigation of Degradation Aspects of Field Deployed Photovoltaic Modules,” NCPV and Solar Program Review Meeting 2003 NREL/CD-520-33586: 958; Wohlgemuth, 1994, “Reliability Testing of PV Modules,” IEEE First World Conference on Photovoltaic Energy Conversion 1: 889-892; and Wohlgemuth et al., 2000, “Reliability and performance testing of photovoltaic modules,” Photovoltaic Specialists Conference, Conference Record of the Twenty-Eighth IEEE: 1483-1486, each of which is hereby incorporated by reference herein in its entirety.

Reduced negative impact on surroundings. Upon absorption of incoming solar radiation, solar cell modules heat up to high temperatures. Such high temperatures may cause adverse effects on the surroundings of the solar cell modules. For example, high temperature solar cell modules overheats roof tops of buildings and are sometimes a fire hazard. As illustrated in FIG. 3F, spacer distance 306, passageway 312 and height 314 help to reduce the temperature of solar cell modules, and therefore also lower the heating effects of the roof. In some embodiments, such reduction will be furthered by implementing additional features in solar cell assembly 300. For example, adding a reflective albedo layer and/or raising the solar cell assembly off installation surface 380 by installing the solar cell assemblies on support frame 508.

Tracking. The present invention further provides the additional benefit of self-tracking. That is, there is no requirement that tracking devices be used to position the assemblies of solar units 1000 of the present invention so that they face sunlight. As noted above, tracking devices are used in the art to enhance the efficiency of solar cells. Tracking devices move with time to follow the movement of the sun. Rather, because of the spacing between solar units 1000 and the spacing between the plane defined by the solar units 1000 and installation surface 380 and/or bottom 406, the solar units 1000 will present the same amount of photovoltaic surface area to direct sunlight during substantial portions of the day.

### 5.4 Exemplary Semiconductor Junctions

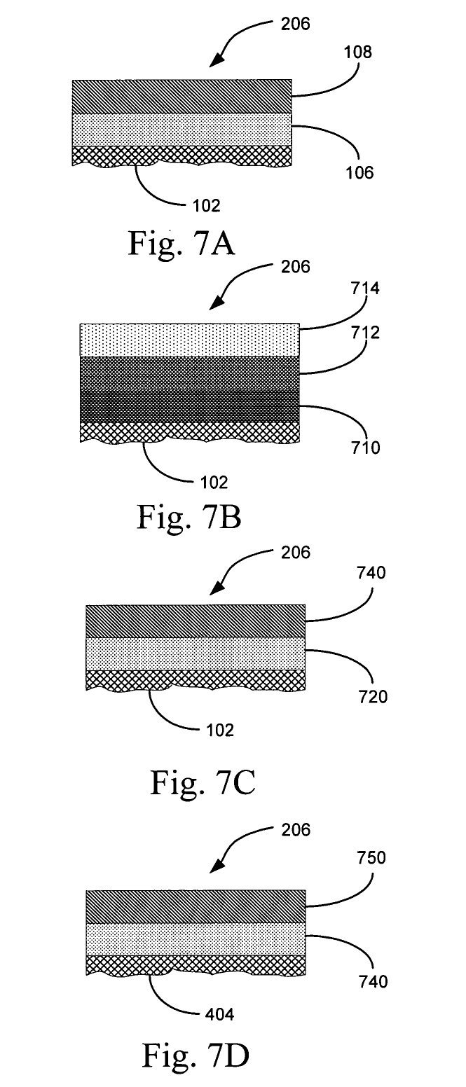

Referring to FIG. 7A, in one embodiment, semiconductor junction 206 is a heterojunction between an absorber layer 106, disposed on back-electrode 104, and a junction partner layer 108, disposed on absorber layer 106. Layers 106 and 108 are composed of different semiconductors with different band gaps and electron affinities such that junction partner layer 106 has a larger band gap than absorber layer 108. In some embodiments, absorber layer 106 is p-doped and junction partner layer 108 is n-doped. In such embodiments, transparent conductive layer 110 (not shown) is n⁺-doped. In alternative embodiments, absorber layer 106 is n-doped and transparent conductive layer 110 is p-doped. In such embodiments, transparent conductive layer 110 is p⁺-doped. In some embodiments, the semiconductors listed in Pandey, Handbook of Semiconductor Electrodeposition, Marcel Dekker Inc., 1996, Appendix 5, which is hereby incorporated by reference herein in its entirety, are used to form semiconductor junction 206.

### 5.4.1 Thin-Film Semiconductor Junctions Based on Copper Indium Diselenide and Other Type I-III-VI Materials

Continuing to refer to FIG. 7A, in some embodiments, absorber layer 106 is a group I-III-VI₂ compound such as copper indium di-selenide (CuInSe₂; also known as CIS). In some embodiments, absorber layer 106 is a group I-III-VI₂ ternary compound selected from the group consisting of CdGeAs₂, ZnSnAs₂, CuInTe₂, AgInTe₂, CuInSe₂, CuGaTe₂, ZnGeAs₂, CdSnP₂, AgInSe₂, AgGaTe₂, CuInS₂, CdSiAs₂, ZnSnP₂, CdGeP₂, ZnSnAs₂, CuGaSe₂, AgGaSe₂, AgInS₂, ZnGeP₂, ZnSiAs₂, ZnSiP₂, CdSiP₂, or CuGaS₂ of either the p-type or the n-type when such compound is known to exist.

In some embodiments, junction partner layer 108 is CdS, ZnS, ZnSe, or CdZnS. In one embodiment, absorber layer 106 is p-type CIS and junction partner layer 108 is n-type CdS, ZnS, ZnSe, or CdZnS. Such semiconductor junctions 406 are described in Chapter 6 of Bube, Photovoltaic Materials, 1998, Imperial College Press, London, which is hereby incorporated by reference in its entirety. Such semiconductor junctions 406 are described in Chapter 6 of Bube, Photovoltaic Materials, 1998, Imperial College Press, London, which is hereby incorporated by reference in its entirety.

In some embodiments, absorber layer 106 is copper-indium-gallium-diselenide (CIGS). Such a layer is also known as Cu(InGa)Se₂. In some embodiments, absorber layer 106 is copper-indium-gallium-diselenide (CIGS) and junction partner layer 108 is CdS, ZnS, ZnSe, or CdZnS. In some embodiments, absorber layer 106 is p-type CIGS and junction partner layer 108 is n-type CdS, ZnS, ZnSe, or CdZnS. Such semiconductor junctions 406 are described in Chapter 13 of Handbook of Photovoltaic Science and Engineering, 2003, Luque and Hegedus (eds.), Wiley & Sons, West Sussex, England, Chapter 12, which is hereby incorporated by reference in its entirety. In some embodiments, layer 106 is between 0.5 μm and 2.0 μm thick. In some embodiments, the composition ratio of Cu/(In+Ga) in layer 502 is between 0.7 and 0.95. In some embodiments, the composition ratio of Ga/(In+Ga) in layer 106 is between 0.2 and 0.4. In some embodiments the CIGS absorber has a <110> crystallographic orientation. In some embodiments the CIGS absorber has a <112> crystallographic orientation. In some embodiments the CIGS absorber is randomly oriented.

### 5.4.2 Semiconductor Junctions Based on Amorphous Silicon or Polycrystalline Silicon

In some embodiments, referring to FIG. 7B, semiconductor junction 206 comprises amorphous silicon. In some embodiments this is an n/n type heterojunction. For example, in some embodiments, layer 714 comprises SnO₂(Sb), layer 712 comprises undoped amorphous silicon, and layer 710 comprises n+ doped amorphous silicon.

In some embodiments, semiconductor junction 206 is a p-i-n type junction. For example, in some embodiments, layer 714 is p⁺ doped amorphous silicon, layer 712 is undoped amorphous silicon, and layer 710 is n⁺ amorphous silicon. Such semiconductor junctions 206 are described in Chapter 3 of Bube, Photovoltaic Materials, 1998, Imperial College Press, London, which is hereby incorporated by reference herein in its entirety.

In some embodiments of the present invention, semiconductor junction 406 is based upon thin-film polycrystalline. Referring to FIG. 7B, in one example in accordance with such embodiments, layer 710 is a p-doped polycrystalline silicon, layer 712 is depleted polycrystalline silicon and layer 714 is n-doped polycrystalline silicon. Such semiconductor junctions are described in Green, Silicon Solar Cells: Advanced Principles & Practice, Centre for Photovoltaic Devices and Systems, University of New South Wales, Sydney, 1995; and Bube, Photovoltaic Materials, 1998, Imperial College Press, London, pp. 57-66, which is hereby incorporated by reference herein in its entirety.

In some embodiments of the present invention, semiconductor junctions 406 based upon p-type microcrystalline Si:H and microcrystalline Si:C:H in an amorphous Si:H solar cell are used. Such semiconductor junctions are described in Bube, Photovoltaic Materials, 1998, Imperial College Press, London, pp. 66-67, and the references cited therein, which is hereby incorporated by reference herein in its entirety.

In some embodiments, of the present invention, semiconductor junction 206 is a tandem junction. Tandem junctions are described in, for example, Kim et al., 1989, “Lightweight (AlGaAs)GaAs/CuInSe2 tandem junction solar cells for space applications,” Aerospace and Electronic Systems Magazine, IEEE Volume 4, Issue 11, November 1989 Page(s):23-32; Deng, 2005, “Optimization of a-SiGe based triple, tandem and single-junction solar cells Photovoltaic Specialists Conference, 2005 Conference Record of the Thirty-first IEEE 3-7 Jan. 2005 Page(s): 1365-1370; Arya et al., 2000, Amorphous silicon based tandem junction thin-film technology: a manufacturing perspective,” Photovoltaic Specialists Conference, 2000, Conference Record of the Twenty-Eighth IEEE 15-22 Sep. 2000 Page(s):1433-1436; Hart, 1988, “High altitude current-voltage measurement of GaAs/Ge solar cells,” Photovoltaic Specialists Conference, 1988, Conference Record of the Twentieth IEEE 26-30 Sep. 1988 Page(s):764-765 vol. 1; Kim, 1988, “High efficiency GaAs/CuInSe2 tandem junction solar cells,” Photovoltaic Specialists Conference, 1988., Conference Record of the Twentieth IEEE 26-30 Sep. 1988 pp. 457-461, vol. 1; Mitchell, 1988, “Single and tandem junction CuInSe2 cell and module technology,” Photovoltaic Specialists Conference, 1988, Conference Record of the Twentieth IEEE 26-30 Sep. 1988 Page(s):1384-1389 vol. 2; and Kim, 1989, “High specific power (AlGaAs)GaAs/CuInSe2 tandem junction solar cells for space applications,” Energy Conversion Engineering Conference, 1989, IECEC-89, Proceedings of the 24^{th} Intersociety 6-11 Aug. 1989 Page(s):779-784 vol. 2, each of which is hereby incorporated by reference herein in its entirety.

### 5.4.3 Semiconductor Junctions Based on Gallium Arsenide and Other Type III-V Materials

In some embodiments, semiconductor junctions 206 are based upon gallium arsenide (GaAs) or other III-V materials such as InP, AlSb, and CdTe. GaAs is a direct-band gap material having a band gap of 1.43 eV and can absorb 97% of AM1 radiation in a thickness of about two microns. Suitable type III-V junctions that can serve as semiconductor junctions of the present invention are described in Chapter 4 of Bube, Photovoltaic Materials, 1998, Imperial College Press, London, which is hereby incorporated by reference herein in its entirety.

Furthermore, in some embodiments semiconductor junction 206 is a hybrid multijunction solar cell such as a GaAs/Si mechanically stacked multijunction as described by Gee and Virshup, 1988, 20^{th} IEEE Photovoltaic Specialist Conference, IEEE Publishing, New York, p. 754, which is hereby incorporated by reference herein in its entirety, a GaAs/CuInSe₂ MSMJ four-terminal device, consisting of a GaAs thin film top cell and a ZnCdS/CuInSe₂ thin bottom cell described by Stanbery et al., 19^{th} IEEE Photovoltaic Specialist Conference, IEEE Publishing, New York, p. 280, and Kim et al., 20^{th} IEEE Photovoltaic Specialist Conference, IEEE Publishing, New York, p. 1487, each of which is hereby incorporated by reference herein in its entirety. Other hybrid multijunction solar cells are described in Bube, Photovoltaic Materials, 1998, Imperial College Press, London, pp. 131-132, which is hereby incorporated by reference herein in its entirety.

### 5.4.4 Semiconductor Junctions Based on Cadmium Telluride and Other Type II-VI Materials

In some embodiments, semiconductor junctions 206 are based upon II-VI compounds that can be prepared in either the n-type or the p-type form. Accordingly, in some embodiments, referring to FIG. 7C, semiconductor junction 206 is a p-n heterojunction in which layers 720 and 740 are any combination set forth in the following table or alloys thereof.

| Layer 720 | Layer 740 |
|---|---|
| n-CdSe | p-CdTe |
| n-ZnCdS | p-CdTe |
| n-ZnSSe | p-CdTe |
| p-ZnTe | n-CdSe |
| n-CdS | p-CdTe |
| n-CdS | p-ZnTe |
| p-ZnTe | n-CdTe |
| n-ZnSe | p-CdTe |
| n-ZnSe | p-ZnTe |
| n-ZnS | p-CdTe |
| n-ZnS | p-ZnTe |

Methods for manufacturing semiconductor junctions 206 are based upon II-VI compounds are described in Chapter 4 of Bube, Photovoltaic Materials, 1998, Imperial College Press, London, which is hereby incorporated by reference herein in its entirety.

### 5.4.5 Semiconductor Junctions Based on Crystalline Silicon

While semiconductor junctions 206 that are made from thin film semiconductor films are preferred, the invention is not so limited. In some embodiments semiconductor junctions 706 is based upon crystalline silicon. For example, referring to FIG. 7D, in some embodiments, semiconductor junction 206 comprises a layer of p-type crystalline silicon 740 and a layer of n-type crystalline silicon 750. Methods for manufacturing crystalline silicon semiconductor junctions 206 are described in Chapter 2 of Bube, Photovoltaic Materials, 1998, Imperial College Press, London, which is hereby incorporated by reference herein in its entirety.

### 6. EXAMPLES

Cylindrical solar units 1000 are arranged parallel or approximately parallel to each other with and without spatial separation. Computer simulation analysis was used to compare absorption levels of solar radiation in different spatial arrangements of solar units 1000. Such modeling is possible because the optical principals associated with solar cells are well known. That is, for any given geometric arrangement of cylindrical solar units 1000, solar absorption, reflection, diffraction, and back reflection from specular, diffuse, and albedo surfaces can be precisely calculated. Furthermore, the characteristics of solar radiation have been well studied. At any given time, the position of the sun in celestial space can be precisely defined by latitude and azimuth. Also, the characteristics of a solar cell assembly can be well defined (e.g., the solar cell dimensions, the sizes of spacer distance and the separation distance between the solar cell assemblies and installation surfaces). Therefore, it is possible to compute levels of radiation, angles of incidence, and amount of solar energy collected for any solar assembly. Computer-simulated data are presented in this section to demonstrate that assemblies of solar units 1000 having solar unit spacer distance 306 and separation distance 314 collect solar radiation more effectively than compactly packed solar cell assemblies that have little or no cell spacer distance 306 and are resting on a substrate and therefore have no separation distance 314.

### 6.1 Spatial Separation in Solar Cell Assemblies

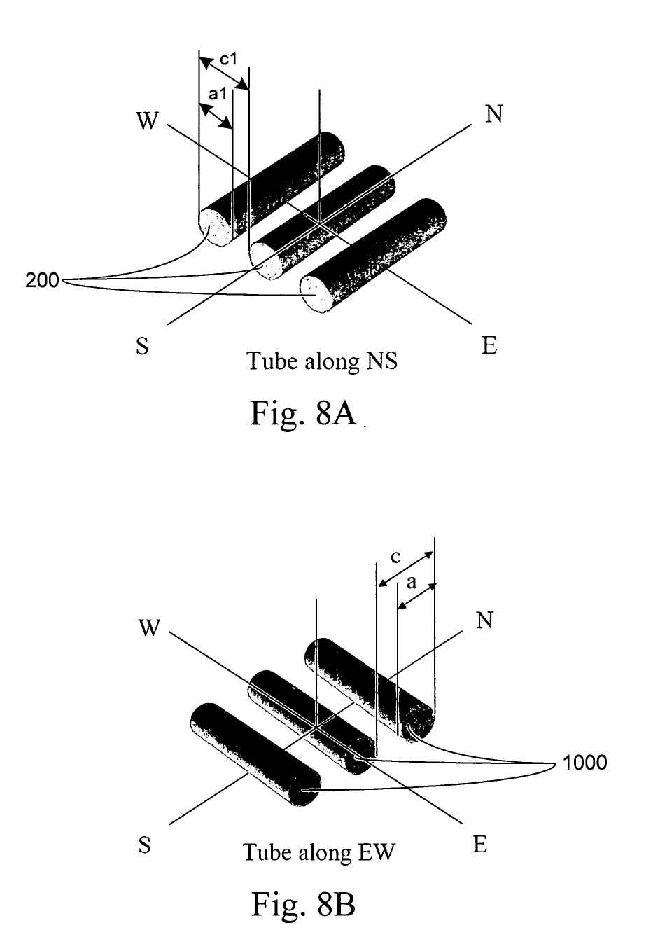

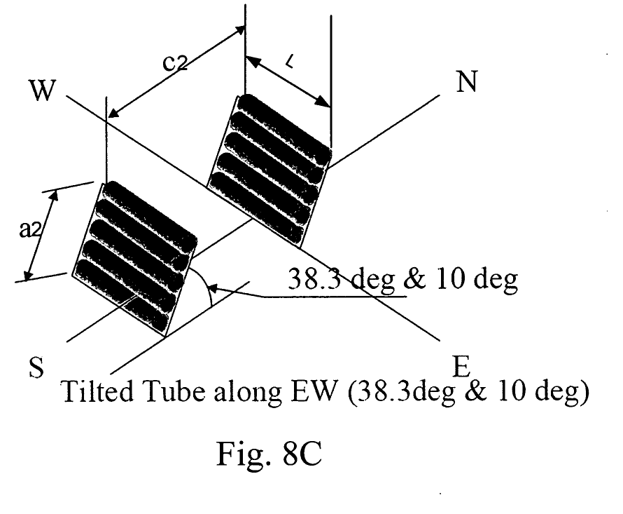

Different spatial arrangements of cylindrical solar units 1000 are defined as shown in FIGS. 8A through 8C. Solar energy collected by cylindrical solar units 1000 in these different arrangements is computed and compared against each other. In FIG. 8A, cylindrical solar units 1000 are arranged such that the long cylindrical axes are aligned along the North-South orientation. The dimension of cylindrical solar units 1000 is a1 and the distance between a cylindrical solar unit and an adjacent neighboring cylindrical solar unit is defined as c1. Since c1 includes spacer distance 306 between these two solar units 1000, the tube coverage of the installation surface may be roughly represented as the ratio of a1 over c1, i.e., a1/c1. For a given type of solar cell arrangement, tube coverage a1/c1 of a solar cell assembly proportionally correlates with material cost. The tube coverage a1/c1 reaches 1 as the spacer distance between cylindrical solar units becomes essentially zero. A tube coverage a1/c1 of 0.5 indicates that the solar units are separated with a spacer distance 306 that is equal to the diameter of a solar unit 1000.

In FIG. 8B, cylindrical solar units 1000 are arranged such that the long cylindrical axis of each solar unit 1000 is aligned in the East-West direction, perpendicular to the orientation of the cylindrical solar units 1000 in FIG. 8A. Similarly to the case of FIG. 8A, the coverage of the installation surface in FIG. 8B may also be roughly represented as the ratio of a1 over c1, i.e., a1/c1. In both FIGS. 8A and 8B, the cylindrical solar units 1000 are assembled with space (spacer distance 306) between adjacent solar units 1000. Such arrangements are also called horizontal grid arrangements.

In FIG. 8C, cylindrical solar units 1000 are packed tightly against each other such that spacer distance 306 between adjacent cylindrical solar units 1000 is negligible. FIG. 8C represents a standard prior art configuration of solar units 1000. In essence, cylindrical solar units 1000 form bifacial panels. In FIG. 8C, because spacer distance 306 is negligible, a new coverage definition was introduced in the modeling studies to capture the percentage coverage concept defined for the configurations depicted in FIGS. 8A and 8B. As shown in FIG. 8C, the size of a solar cell assembly may be defined by its width a2 and length l. As the installation area of the solar cell assembly may be defined by its panel separation c2 and cell length l. As a result, the tube coverage for bificial panels, as depicted in FIG. 8C, may also be estimated as a2/c2.

With these definitions for installation areas defined for the bifacial panel embodiments depicted in FIG. 8, the amount of solar energy collected is analyzed with respect to different tilt angles (as depicted in FIG. 8C). More specifically, solar energy collected at two different tilt angles, 38.3 degrees and 10 degrees was analyzed for each of the three configurations (FIGS. 8A, 8B, and 8C). Simulated annual solar energy collected using different solar cell arrangements were compared and studied. The results of this analysis is described below.

### 6.2 Spatially Separated Solar Units are More Effective in Collecting Solar Energy

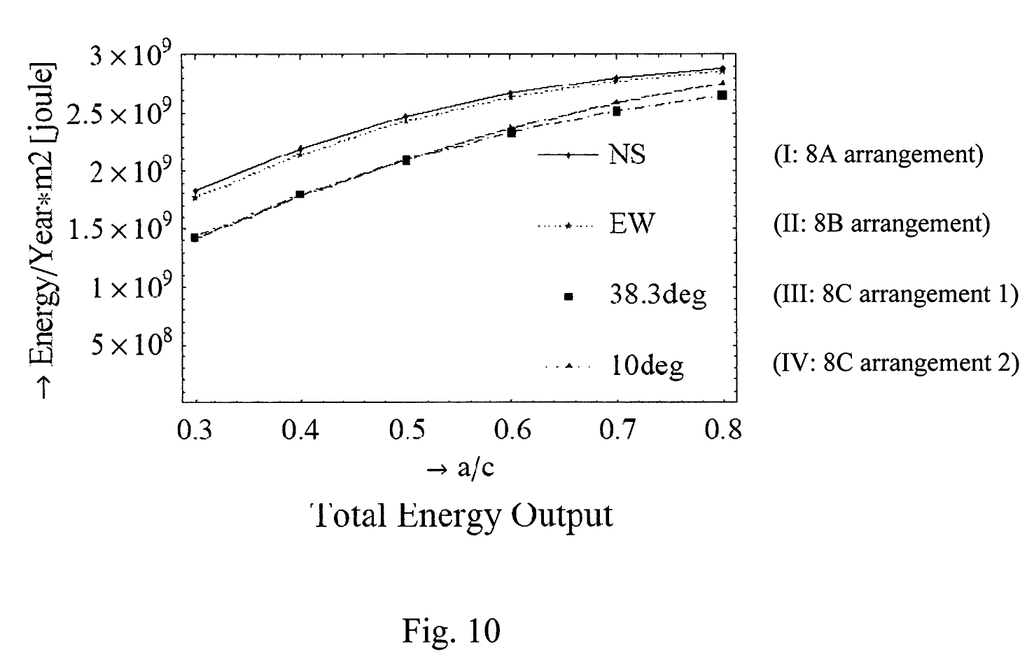

Computer simulation experiments were carried out to estimate annual solar energy collected by each solar cell arrangement defined in the previous section. FIG. 10 summarizes and compares the results from the simulation study. Total annual solar energy collected with each solar cell arrangement is plotted as the function of tube coverage value for each type of solar cell arrangement. FIG. 10 demonstrates that the spatially separated solar cell arrangements, as depicted in FIGS. 8A and 8B, are more effective in collecting solar energy than the panel-like prior art solar cell arrangement depicted in FIG. 8C. FIG. 10 also demonstrate that, given the same spatially separated solar cell assembly, the orientation of the solar cell assembly does not affect solar energy collection. The energy collection curve for the North-South oriented tubes is almost identical to the energy collected curve for the East-West oriented tubes (e.g., as shown in curves I and II in FIG. 10). FIG. 10 also demonstrates that solar cell panels formed by cylindrical/tubular solar cells do not have a solar absorption profile that depends upon tilt angles. For example, the solar cell panel depicted in FIG. 8C does not show much difference in solar energy collected when tilted at 38.3 degrees or at 10 degrees (e.g., as shown in curves III and IV in FIG. 10).

### 6.3 Variation and Composition of Yearly Solar Radiation

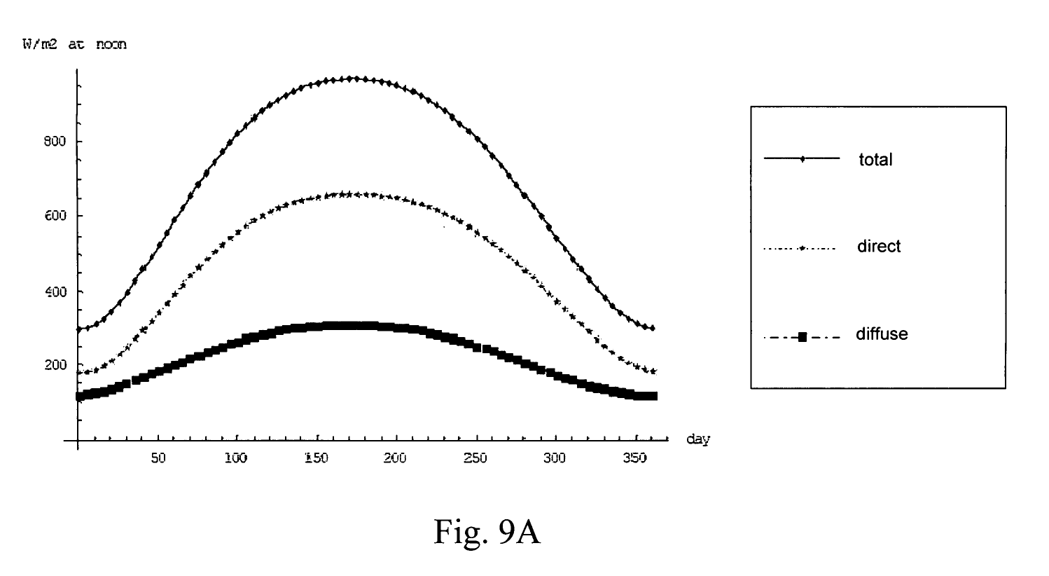

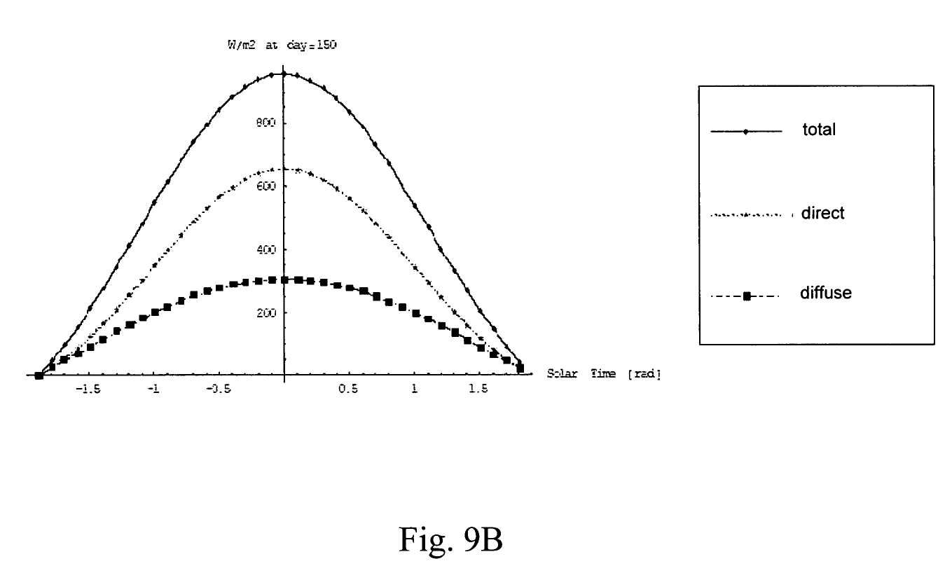

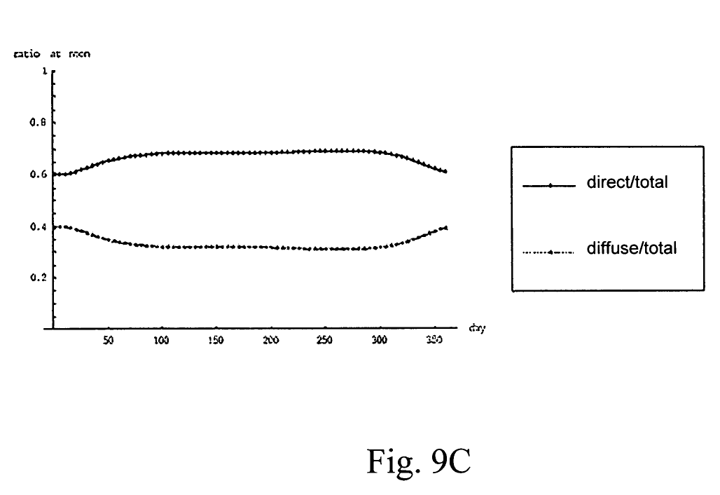

In FIGS. 9A through 9C, the natural variation of solar radiation was analyzed. As depicted in FIGS. 9A through 9C, total solar radiation collected by solar cells was broken down into two components: direct radiation and diffuse radiation. Total radiation refers to the total amount of solar radiation that is absorbed by a solar cell assembly. Direct radiation is the portion of the total energy that is absorbed in the form of direct incident light. Diffuse radiation represents the energy from solar light that is scattered by dirt and other small particles in the atmosphere, assuming that the ground surface has a zero reflectivity.

FIG. 9A illustrates the yearly variation of insolation at noon at the latitude of 38.3 degrees. As shown in the energy curves, energies from total radiation, direct radiation, and diffuse radiation all peak around day 175, i.e., around Summer Solstice when solar cell exposure to solar radiation is the longest in Northern Hemisphere. Not surprisingly, all three forms of energies should reach their minimum around Winter Solstice.

Similarly, solar radiation also varies with respect to different time during a single day. For example, as depicted in FIG. 9B, on day 150 at latitude 38.3, all three forms of energies peak around noon. In FIG. 9B, time on the x axis is defined as solar time of angle of incidence for incoming solar radiation. For example, when the sun is at horizon, the angle of incidence is 90 degree, i.e., ½π or 1.57. At noon, the angle of incidence is zero, solar time is thus 0π or 0. FIG. 9B thus depicts variation of solar radiation from sunrise to sunset.

FIG. 9C depicts the relative composition of total energy collected by solar cell assemblies. Energy from direct solar radiation is the dominant form of energy, while energy from diffuse solar radiation is the minor form of energy.

### 6.4 Composition of Energies Absorbed by Different Arrangements

In addition to direct and diffuse radiation, the addition of an albedo layer introduces a new form of energy that is also absorbed by solar units 1000, the albedo sub-form of energy. The albedo sub-form of energy is present when the ground or other surfaces reflect solar radiation back towards solar units 1000. In the simulation study, an albedo value of 80 percent was used to calculated the energy collected through albedo reflection.

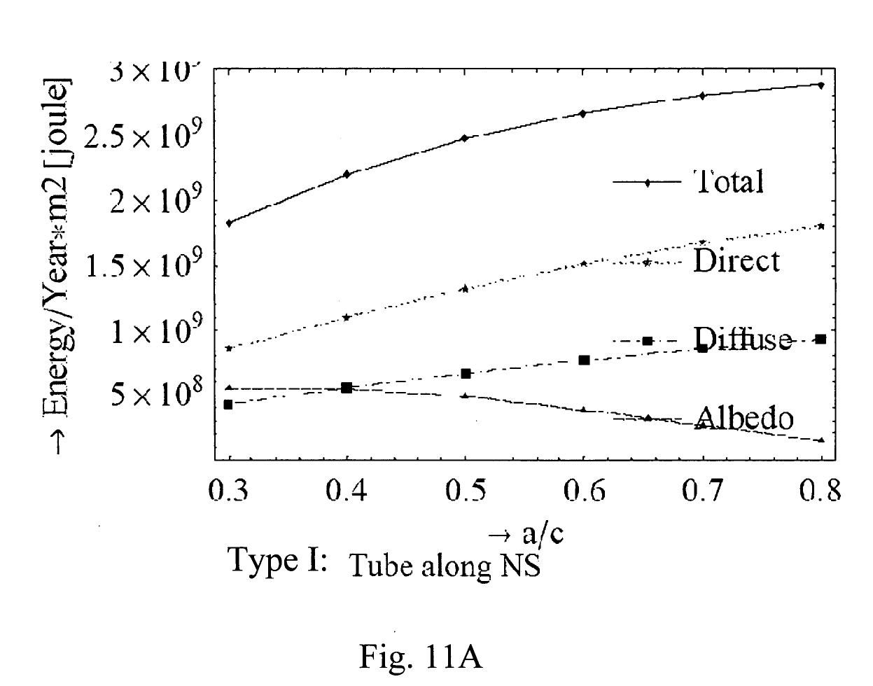

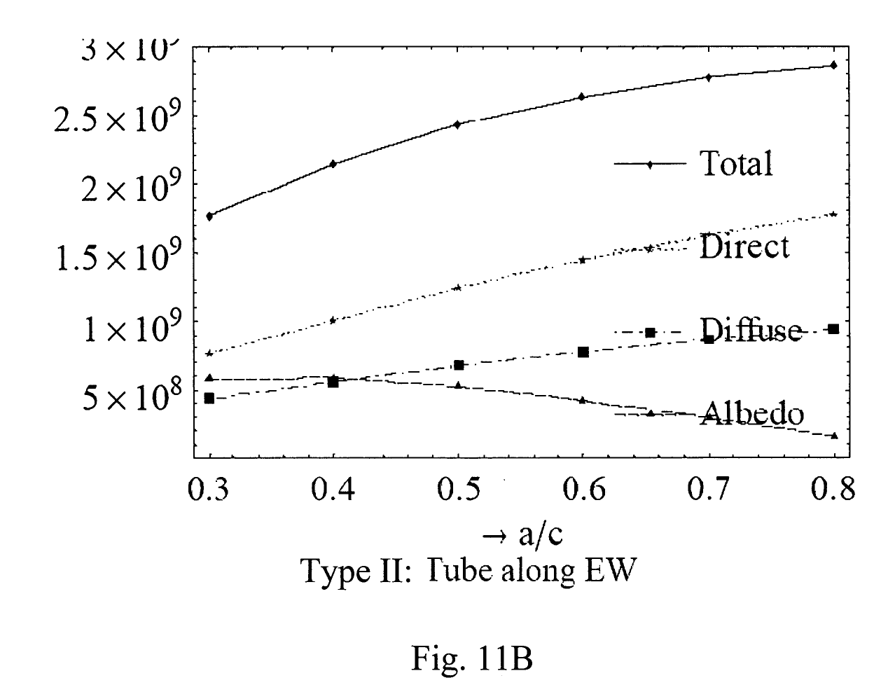

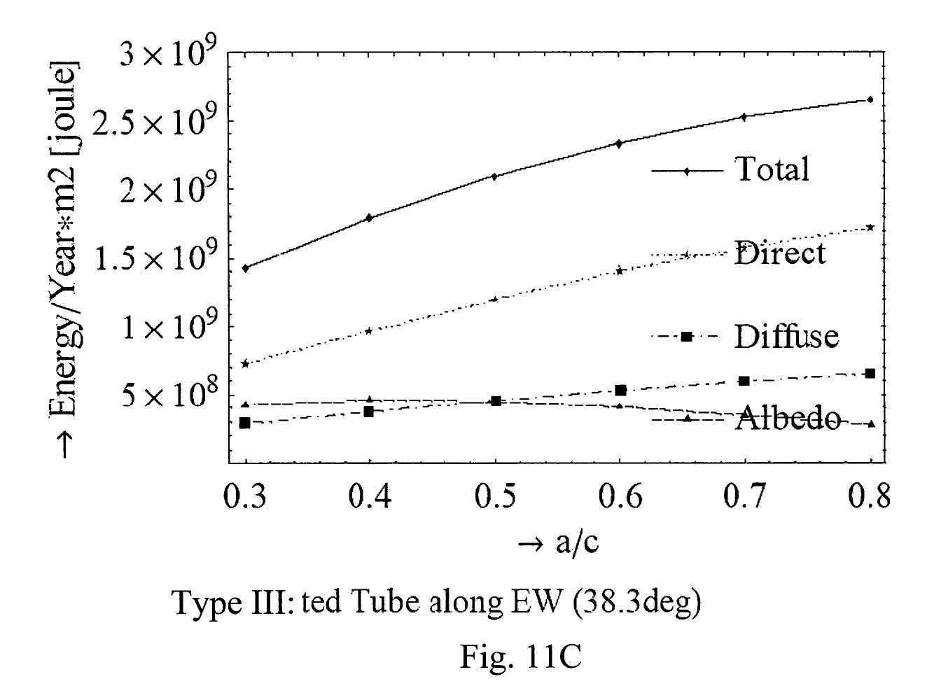

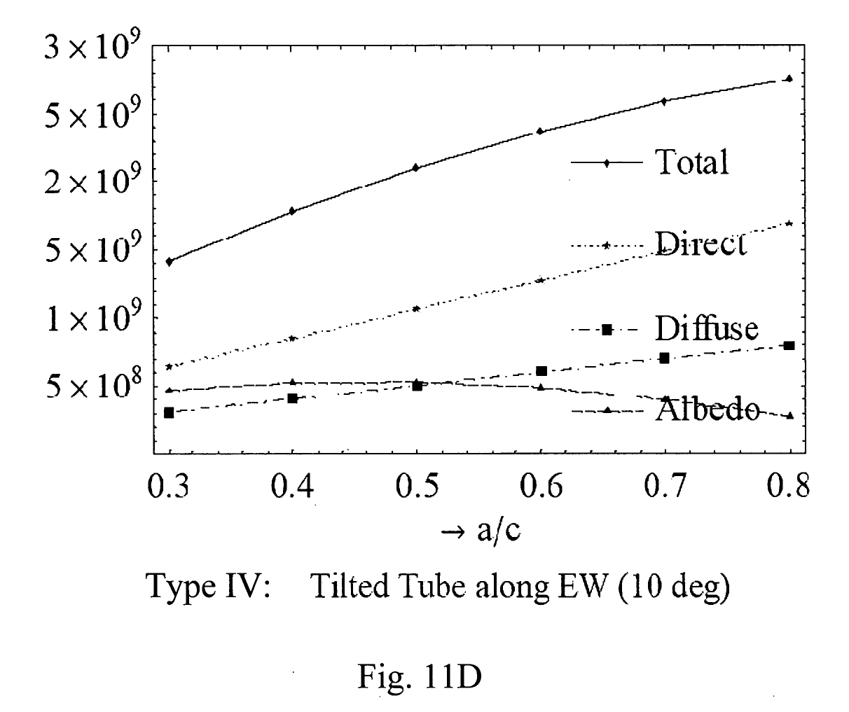

In FIGS. 11A through 11D, the four total energy absorption curves depicted in FIG. 10 are further broken down into three sub-forms: direct, diffuse, and albedo. As shown in FIGS. 11A through 11D, energy from direct solar radiation is still the dominant form of energy absorbed by solar units 1000 in all four different arrangements. In all types of arrangements, energy absorption increases proportionally with increase in tube coverage.

Interestingly, it is confirmed that an albedo layer significantly contributes to total amount of energy absorbed. Under all four different arrangements, when there are significant amount of installation surface exposed (the installation surface is covered by high albedo material), the amount energy absorbed due to the high albedo layer is higher than the amount energy absorbed due to diffuse solar radiation. For example, at coverage of 0.3, i.e., only about a third of the installation field is covered, the amount energy absorbed due to the high albedo layer is higher than the amount energy absorbed due to diffuse solar radiation. The amount of energy absorbed due to albedo decreases as tube coverage increases. Even though albedo energy is still a minor composition of the total amount of energy absorbed by the solar units 1000, the contribution from albedo is to be appreciated when the cost of solar units 1000 is taken into consideration. When tube coverage increases beyond 0.6, production of solar units 1000 becomes significantly costly that arrangements with such high tube coverage are essentially impractical.

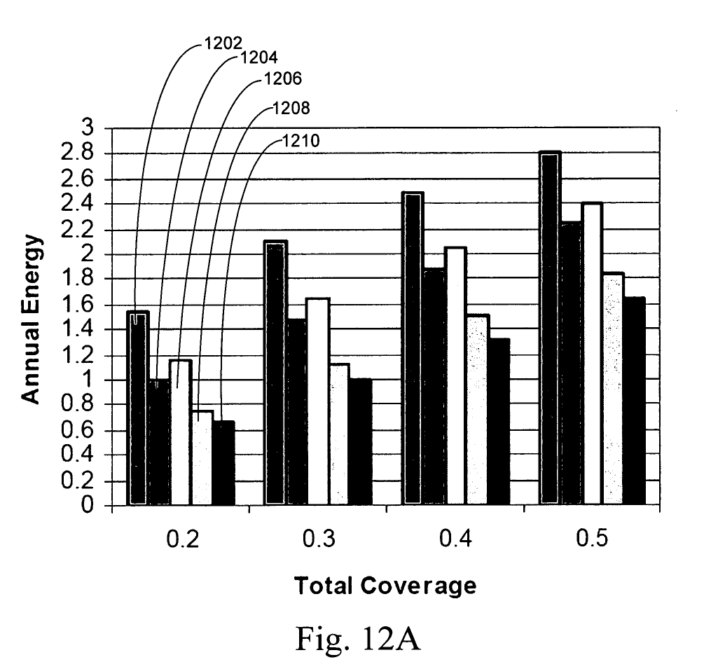

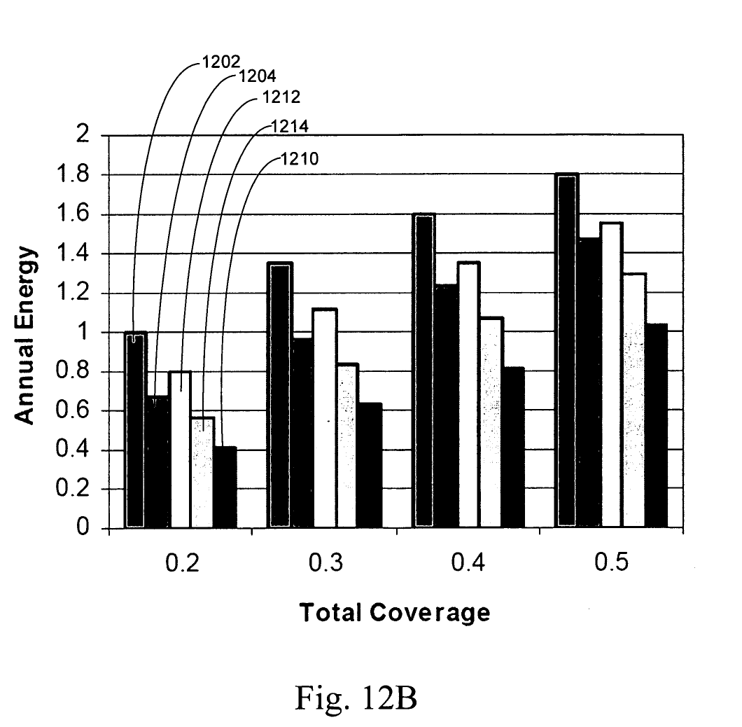

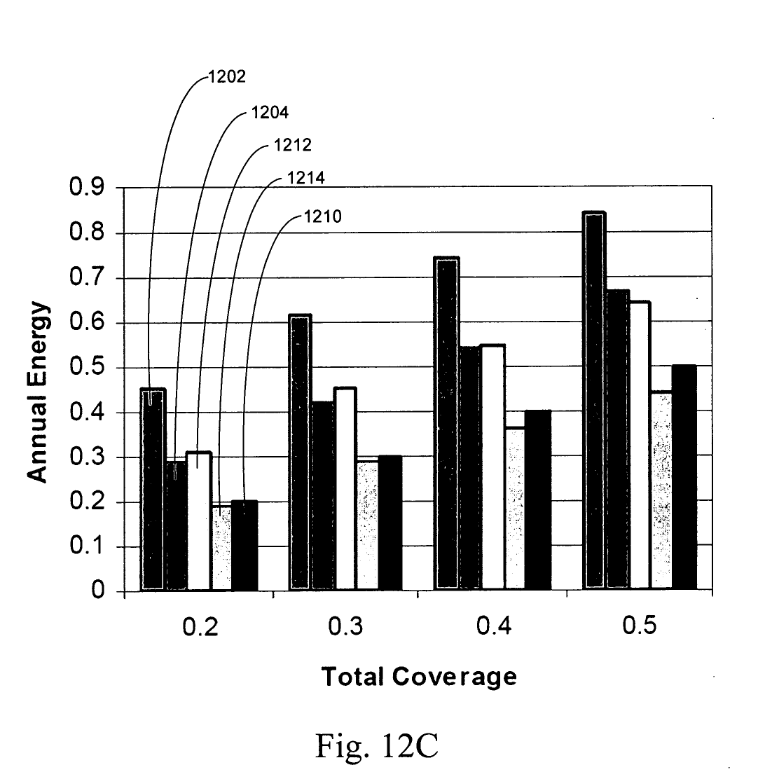

FIGS. 12A and 12B compare simulated energy collected at two different geographic locations: Newark and Churchill. Newark and Churchill are both located in the Northern Hemisphere with latitude values of 40.7 and 58.4, respectively. In addition to the solar cell arrangement described in Section 6.1, above, solar energy collected by a generic monofacial solar panel is also included as a control in the simulation study. In both locations, solar radiation absorption by each solar cell arrangement is simulated. For each arrangement, simulation is also performed at four different tube coverage levels: 0.2, 0.3, 0.4 and 0.5. The different solar cell arrangements studied include a horizontal grid arrangement with albedo layer (e.g., 1202 in FIGS. 12A and 12B), a horizontal grid arrangement without albedo layer (e.g., 1204 in FIGS. 12A and 12B), monofacial and bifacial planar panel arrangements at a tilt angle of 20 degrees (e.g., 1206 and 1208 in FIG. 12A), monofacial and bifacial planar arrangements at a tilt angle of 40 degrees (e.g., 1212 and 1214 in FIG. 12B), and a horizontally positional planar arrangement without albedo (e.g., 1210 in FIGS. 12A and 12B).

In FIG. 12C, the capacity of each solar cell arrangement in collecting diffuse solar radiation was analyzed by computer simulation. FIG. 12C demonstrates that the high efficiency of the horizontal grid solar cell arrangement is mainly due to their efficiency in collecting diffuse solar radiation. The above simulation data demonstrates that, in different locations, horizontal grid arrangements with albedo is the most effective arrangement form for collecting solar radiation. Such high efficiency is independent of tube coverage.

### 6.5 Conclusion

Arrays or cylindrical/tubular solar units 1000 arranged parallel to each other in a planar or near planar assembly such that each solar unit 1000 in the assembly is arranged at an appreciable spacer distance 306 to neighboring solar units 1000 are highly effective in collecting solar energy. Solar cell assemblies formed by cylindrical solar units 1000 are not sensitive to tilt angles between the assemblies and the installation surface. When cylindrical solar units 1000 are arranged with spatial separation between the solar units, they collect solar energy more effectively than comparable arrangements in which all the solar units are tightly packed against each other.

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. A solar cell arrangement comprising:
a first solar cell assembly comprising a first plurality of cylindrical solar units arranged parallel or approximately parallel to each other in a common plane, wherein
each cylindrical solar unit in the first plurality of cylindrical solar units is at least a separation distance away from an installation surface; and
a first and a second cylindrical solar unit in said first plurality of cylindrical solar units are separated from each other by a spacer distance thereby allowing direct sunlight to pass between said first and second cylindrical solar unit onto said installation surface.

2. The solar cell arrangement of claim 1 further comprising a second solar cell assembly comprising a second plurality of cylindrical solar units arranged parallel or approximately parallel to each other in a common plane, wherein
a third and a fourth cylindrical solar unit in said second plurality of cylindrical solar units are separated from each other by said spacer distance thereby allowing direct sunlight to pass between said third and fourth cylindrical solar unit; and
each cylindrical solar unit in the second plurality of cylindrical solar units is at least said separation distance away from an installation surface; and wherein
said first solar cell assembly and said second solar cell assembly are separated from each other by a passageway distance.

3. The solar cell arrangement of claim 2, wherein said separation distance is greater than said passageway distance.

4. The solar cell arrangement of claim 1, wherein the first plurality of cylindrical solar units comprises 20 or more cylindrical solar units.

5. The solar cell arrangement of claim 1, wherein the first plurality of cylindrical solar units comprises 100 or more cylindrical solar units.

6. The solar cell arrangement of claim 1, wherein the first plurality of cylindrical solar units comprises 500 or more cylindrical solar units.

7. The solar cell arrangement of claim 1, wherein a cylindrical solar unit in said first plurality of cylindrical solar units has a diameter of between 1 centimeter and 6 centimeters.

8. The solar cell arrangement of claim 1, wherein a cylindrical solar unit in said first plurality of cylindrical solar units has a diameter that is 5 centimeters or larger.

9. The solar cell arrangement of claim 1, wherein a cylindrical solar unit in said first plurality of cylindrical solar units has a diameter that is 10 centimeters or larger.

10. The solar cell arrangement of claim 1, wherein said spacer distance is 0.1 centimeters or more.

11. The solar cell arrangement of claim 1, wherein said spacer distance is 1 centimeter or more.

12. The solar cell arrangement of claim 1, wherein said spacer distance is 5 centimeters or more.

13. The solar cell arrangement of claim 1, wherein said spacer distance is less than 10 centimeters.

14. The solar cell arrangement of claim 1, wherein said spacer distance is at least equal to or greater than a diameter of a cylindrical solar unit in said first plurality of cylindrical solar units.

15. The solar cell arrangement of claim 1, wherein said spacer distance is at least equal to or greater than two times a diameter of a cylindrical solar unit in said first plurality of cylindrical solar units.

16. The solar cell arrangement of claim 1, wherein a spacer distance between a first and a second cylindrical solar unit in said first plurality of cylindrical solar units is different than a spacer distance between a third and a fourth cylindrical solar unit in said first plurality of cylindrical solar units.

17. The solar cell arrangement of claim 1, wherein a spacer distance between a first and a second cylindrical solar unit in said first plurality of cylindrical solar units is the same as a spacer distance between a third and a fourth cylindrical solar unit in said first plurality of cylindrical solar units.

18. The solar cell arrangement of claim 1, wherein said installation surface is overlayed with an albedo surface.

19. The solar cell arrangement of claim 18, wherein said albedo surface has an albedo of at least sixty percent.

20. The solar cell arrangement of claim 18, wherein said albedo surface is a Lambertian or diffuse reflector surface.

21. The solar cell arrangement of claim 18, wherein said albedo surface is overlayed with a self-cleaning layer.

22. The solar cell arrangement of claim 1, wherein said separation distance is twenty-five centimeters or more.

23. The solar cell arrangement of claim 1, wherein said separation distance is two meters or more.

24. The solar cell arrangement of claim 1, wherein a cylindrical solar unit in said first plurality of cylindrical solar units comprises:
a substrate that is either (i) tubular shaped or (ii) rigid solid rod shaped;
a back-electrode circumferentially disposed on the substrate;
a semiconductor junction layer circumferentially disposed on said back-electrode; and
a transparent conductive layer circumferentially disposed on said semiconductor junction.

25. The solar cell arrangement of claim 24, wherein the cylindrical solar unit further comprises a transparent tubular casing circumferentially sealed onto said cylindrical solar unit.

26. The solar cell arrangement of claim 25, wherein the transparent tubular casing is made of plastic or glass.

27. The solar cell arrangement of claim 25, wherein the substrate comprises plastic, glass, a metal, or a metal alloy.

28. The solar cell arrangement of claim 25, wherein the substrate is tubular shaped and a fluid is passed through said substrate.

29. The solar cell arrangement of claim 25, wherein said semiconductor junction comprises an absorber layer and a junction partner layer, and wherein said junction partner layer is circumferentially disposed on said absorber layer.

30. The solar cell arrangement of claim 29, wherein said absorber layer is copper-indium-gallium-diselenide and said junction partner layer is In₂Se₃, In₂S₃, ZnS, ZnSe, CdInS, CdZnS, ZnIn₂Se₄, Zn₁₋ₓMgₓO, CdS, SnO₂, ZnO, ZrO₂, or doped ZnO.

31. The solar cell arrangement of claim 1, further comprising:
a plurality of internal reflectors, wherein each respective internal reflector in the plurality of internal reflectors is configured between a corresponding first and second cylindrical solar unit in said plurality of cylindrical solar units such that a portion of the solar light reflected from the respective internal reflector is reflected onto the corresponding first cylindrical solar unit.

32. The solar cell arrangement of claim 31, wherein an internal reflector in said plurality of internal reflectors has a hollow core.

33. The solar cell arrangement of claim 31, wherein an internal reflector in said plurality of internal reflectors comprises a plastic casing with a layer of reflective material deposited on said plastic casing.

34. The solar cell arrangement of claim 33, wherein the layer of reflective material is polished aluminum, aluminum alloy, silver, nickel or steel.

35. The solar cell arrangement of claim 31, wherein an internal reflector in said plurality of internal reflectors is a single piece made out of a reflective material.

36. The solar cell arrangement of claim 35, wherein the reflective material is polished aluminum, aluminum alloy, silver, nickel or steel.

37. The solar cell arrangement of claim 31, wherein an internal reflector in said plurality of internal reflectors comprises a plastic casing onto which is layered a metal foil tape.

38. The solar cell arrangement of claim 37, wherein the metal foil tape is aluminum foil tape.

39. The solar cell arrangement of claim 1, wherein a first and a second cylindrical solar unit in said plurality of solar units are in serial electrical communication.

40. The solar cell arrangement of claim 1, wherein a first and a second cylindrical solar unit in said first plurality of solar units are in parallel electrical communication.

41. The solar cell arrangement of claim 1, wherein a first and a second cylindrical solar unit in said first plurality of solar units are electrically isolated from each other.

42. The solar cell arrangement of claim 1, wherein said separation distance is greater than said spacer distance.

43. The solar cell arrangement of claim 1, wherein said separation distance is less than said spacer distance.

44. The solar cell arrangement of claim 1, wherein a cylindrical solar unit in said first plurality of solar units comprises:
(A) a cylindrical substrate having a first end and a second end; and
(B) a plurality of solar cells linearly arranged on said substrate, the plurality of solar cells comprising a first solar cell and a second solar cell, each solar cell in said plurality of solar cells comprising:
a back-electrode circumferentially disposed on said substrate;
a semiconductor junction layer circumferentially disposed on said back-electrode; and
a transparent conductive layer circumferentially disposed on said semiconductor junction, wherein
the transparent conductive layer of the first solar cell in said plurality of solar cells is in serial electrical communication with the back-electrode of the second solar cell in said plurality of solar cells.

45. The solar cell arrangement of claim 44, wherein said plurality of solar cells comprises:
a first terminal solar cell at the first end of said cylindrical substrate;
a second terminal solar cell at the second end of said cylindrical substrate; and
at least one intermediate solar cell between said first terminal solar cell and said second solar cell, wherein the transparent conductive layer of each intermediate solar cell in said at least one intermediate solar cell is in serial electrical communication with the back-electrode of an adjacent solar cell in said plurality of solar cells.

46. The solar cell arrangement of claim 45, wherein the adjacent solar cell is the first terminal solar cell or the second terminal solar cell.

47. The solar cell arrangement of claim 45, wherein the adjacent solar cell is another intermediate solar cell.

48. The solar cell arrangement of claim 44, wherein the plurality of solar cells comprises three or more solar cells.

49. The solar cell arrangement of claim 44, wherein the plurality of solar cells comprises ten or more solar cells.

50. The solar cell arrangement of claim 44, wherein the plurality of solar cells comprises fifty or more solar cells.

51. The solar cell arrangement of claim 44, wherein the plurality of solar cells comprises one hundred or more solar cells.

52. The solar cell arrangement of claim 44, further comprising a transparent tubular casing that is circumferentially sealed onto the transparent conductive layer of all or a portion of the solar cells in said plurality of solar cells.

53. The solar cell arrangement of claim 52, wherein the transparent tubular casing is made of plastic or glass.

54. The solar cell arrangement of claim 52, wherein the transparent tubular casing comprises aluminosilicate glass, borosilicate glass, dichroic glass, germanium/semiconductor glass, glass ceramic, silicate/fused silica glass, soda lime glass, quartz glass, chalcogenide/sulphide glass, fluoride glass, flint glass, or cereated glass.

55. The solar cell arrangement of claim 52, wherein the transparent tubular casing comprises a fluoropolymer, polymethylmethacrylate (PMMA), poly-dimethyl siloxane (PDMS), ethyl vinyl acetate (EVA), perfluoroalkoxy fluorocarbon (PFA), nylon, cross-linked polyethylene (PEX), polypropylene (PP), polyethylene terephtalate glycol (PETG), polytetrafluoroethylene (PTFE), polyvinyl chloride (PVC), or polyvinylidene fluoride (PVDF).

56. The solar cell arrangement of claim 44, wherein the cylindrical substrate comprises plastic, metal or glass.

57. The solar cell arrangement of claim 44, wherein the cylindrical substrate comprises a urethane polymer, an acrylic polymer, a fluoropolymer, polybenzamidazole, polymide, polytetrafluoroethylene, polyetheretherketone, polyamide-imide, glass-based phenolic, polystyrene, cross-linked polystyrene, polyester, polycarbonate, polyethylene, polyethylene, acrylonitrile-butadiene-styrene, polytetrafluoro-ethylene, polymethacrylate, nylon 6,6, cellulose acetate butyrate, cellulose acetate, rigid vinyl, plasticized vinyl, or polypropylene.

58. The solar cell arrangement of claim 1, wherein a concentrator or reflector overlays said installation surface.

59. The solar cell arrangement of claim 1, wherein a compound parabolic concentrator overlays said installation surface.

60. The solar cell arrangement of claim 58, wherein a v-groove reflector overlay said installation surface.

61. A solar cell arrangement comprising:
a solar cell assembly comprising a plurality of cylindrical solar units arranged parallel or approximately parallel to each other in a common plane; and
a casing comprising a bottom and a plurality of transparent side panels, wherein said casing encloses said solar cell assembly, and wherein
a first and a second cylindrical solar unit in said first plurality of cylindrical solar units are separated from each other by a spacer distance thereby allowing direct sunlight to pass between said first and second cylindrical solar unit onto said bottom of said box-like casing; and
each cylindrical solar unit in the plurality of cylindrical solar units is at least a separation distance away from said bottom of said casing.

62. The solar cell arrangement of claim 61, wherein said separation distance is greater than said spacer distance.

63. The solar cell arrangement of claim 61, wherein the casing further comprises a top layer that seals said casing and shields said plurality of cylindrical solar units from direct solar radiation.

64. The solar cell arrangement of claim 61, wherein a first side of the top layer is coated with an anti-reflective coating, wherein said first side faces outward from said casing.

65. The solar cell arrangement of claim 61, wherein said plurality of transparent side panels comprises transparent plastic or glass.

66. The solar cell arrangement of claim 61, wherein said plurality of transparent side panels comprises aluminosilicate glass, borosilicate glass, dichroic glass, germanium/semiconductor glass, glass ceramic, silicate/fused silica glass, soda lime glass, quartz glass, chalcogenide/sulphide glass, fluoride glass, flint glass, or cereated glass.

67. The solar cell arrangement of claim 61, wherein said plurality of transparent side panels comprises a urethane polymer, an acrylic polymer, a fluoropolymer, a polyamide, a polyolefin, polymethylmethacrylate (PMMA), a poly-dimethyl siloxane (PDMS), ethyl vinyl acetate (EVA), perfluoroalkoxy fluorocarbon (PFA), nylon/polyamide, cross-linked polyethylene (PEX), polypropylene (PP), polyethylene terephtalate glycol (PETG), polytetrafluoroethylene (PTFE), thermoplastic copolymer, a polyurethane/urethane, a transparent polyvinyl chloride (PVC), a polyvinylidene fluoride (PVDF), or any combination thereof.

68. The solar cell arrangement of claim 61, wherein the plurality of cylindrical solar units comprises 20 or more cylindrical solar units.

69. The solar cell arrangement of claim 61, wherein the plurality of cylindrical solar units comprises 500 or more cylindrical solar units.

70. The solar cell arrangement of claim 61, wherein a cylindrical solar unit in said plurality of cylindrical solar units has a diameter of between 1 centimeter and 6 centimeters.

71. The solar cell arrangement of claim 61, wherein a cylindrical solar unit in said plurality of cylindrical solar units has a diameter that is 5 centimeters or larger.

72. The solar cell arrangement of claim 61, wherein a cylindrical solar unit in said plurality of cylindrical solar units has a diameter that is 10 centimeters or larger.

73. The solar cell arrangement of claim 61, wherein said spacer distance is 0.1 centimeters or more.

74. The solar cell arrangement of claim 61, wherein said spacer distance is 1 centimeter or more.

75. The solar cell arrangement of claim 61, wherein said spacer distance is less than 10 centimeters.

76. The solar cell arrangement of claim 61, wherein said spacer distance is at least equal to or greater than a diameter of a cylindrical solar unit in said first plurality of cylindrical solar units.

77. The solar cell arrangement of claim 61, wherein the spacer distance between a first and second solar unit in said plurality of cylindrical solar units is different than a spacer distance between a third and a forth cylindrical solar unit in said plurality of cylindrical solar units.

78. The solar cell arrangement of claim 61, wherein a spacer distance between a first and a second cylindrical solar unit in the plurality of cylindrical solar units is different than a space distance between a third and a fourth cylindrical solar unit in the plurality of cylindrical solar units.

79. The solar cell arrangement of claim 61, wherein said bottom is overlayed with an albedo surface.

80. The solar cell arrangement of claim 79, wherein said albedo surface has an albedo of at least sixty percent.

81. The solar cell arrangement of claim 79, wherein said albedo surface is a Lambertian or diffuse reflector surface.

82. The solar cell arrangement of claim 79, wherein said albedo surface is overlayed with a self-cleaning layer.

83. The solar cell arrangement of claim 61, wherein said bottom comprises an albedo face.

84. The solar cell arrangement of claim 83, wherein said albedo face has an albedo of at least sixty percent.

85. The solar cell arrangement of claim 61, wherein said separation distance is twenty-five centimeters or more.

86. The solar cell arrangement of claim 61, wherein said separation distance is two meters or more.

87. The solar cell arrangement of claim 61, wherein a cylindrical solar unit in said first plurality of cylindrical solar units comprises:
a substrate that is either (i) tubular shaped or (ii) rigid solid rod shaped;
a back-electrode circumferentially disposed on the substrate;
a semiconductor junction layer circumferentially disposed on said back-electrode; and
a transparent conductive layer circumferentially disposed on said semiconductor junction.

88. The solar cell arrangement of claim 87, wherein the cylindrical solar unit further comprises a transparent tubular casing circumferentially sealed onto said cylindrical shaped solar unit.

89. The solar cell arrangement of claim 88, wherein the transparent tubular casing is made of plastic or glass.

90. The solar cell arrangement of claim 87, wherein the substrate comprises plastic, glass, a metal, or a metal alloy.

91. The solar cell arrangement of claim 87, wherein the substrate is tubular shaped and a fluid is passed through said substrate.

92. The solar cell arrangement of claim 87, wherein said semiconductor junction comprises an absorber layer and a junction partner layer, and wherein said junction partner layer is circumferentially disposed on said absorber layer.

93. The solar cell arrangement of claim 92, wherein said absorber layer is copper-indium-gallium-diselenide and said junction partner layer is In₂Se₃, In₂S₃, ZnS, ZnSe, CdInS, CdZnS, ZnIn₂Se₄, Zn₁₋ₓMgₓO, CdS, SnO₂, ZnO, ZrO₂, or doped ZnO.

94. The solar cell arrangement of claim 61, further comprising:
a plurality of internal reflectors, wherein each respective internal reflector in the plurality of internal reflectors is configured between a corresponding first and second cylindrical solar unit in said plurality of cylindrical solar units such that a portion of the solar light reflected from the respective internal reflector is reflected onto the corresponding first cylindrical solar unit.

95. The solar cell arrangement of claim 61, wherein a first and a second cylindrical solar unit in said plurality of cylindrical solar units are in serial electrical communication.

96. The solar cell arrangement of claim 61, wherein a first and a second cylindrical solar unit in said plurality of cylindrical solar units are in parallel electrical communication.

97. The solar cell arrangement of claim 61, wherein a first and a second cylindrical solar unit in said plurality of cylindrical solar units are electrically isolated from each other.

98. The solar cell arrangement of claim 61, wherein said separation distance is less than said spacer distance.

99. The solar cell arrangement of claim 61, wherein a cylindrical solar unit in said plurality of solar units comprises:
(A) a cylindrical substrate having a first end and a second end; and
(B) a plurality of solar cells linearly arranged on said substrate, the plurality of solar cells comprising a first solar cell and a second solar cell, each solar cell in said plurality of solar cells comprising:
a back-electrode circumferentially disposed on said substrate;
a semiconductor junction layer circumferentially disposed on said back-electrode; and
a transparent conductive layer circumferentially disposed on said semiconductor junction, wherein
the transparent conductive layer of the first solar cell in said plurality of solar cells is in serial electrical communication with the back-electrode of the second solar cell in said plurality of solar cells.

100. The solar cell arrangement of claim 99, wherein said plurality of solar cells comprises:
a first terminal solar cell at the first end of said cylindrical substrate;
a second terminal solar cell at the second end of said cylindrical substrate; and
at least one intermediate solar cell between said first terminal solar cell and said second solar cell, wherein the transparent conductive layer of each intermediate solar cell in said at least one intermediate solar cell is in serial electrical communication with the back-electrode of an adjacent solar cell in said plurality of solar cells.

101. The solar cell arrangement of claim 100, wherein the adjacent solar cell is the first terminal solar cell or the second terminal solar cell.

102. The solar cell arrangement of claim 100, wherein the adjacent solar cell is another intermediate solar cell.

103. The solar cell arrangement of claim 99, wherein the plurality of solar cells comprises three or more solar cells.

104. The solar cell arrangement of claim 99, wherein the plurality of solar cells comprises ten or more solar cells.

105. The solar cell arrangement of claim 99, further comprising a transparent tubular casing that is circumferentially sealed onto the transparent conductive layer of all or a portion of the solar cells in said plurality of solar cells.

106. The solar cell arrangement of claim 105, wherein the transparent tubular casing is made of plastic or glass.

107. The solar cell arrangement of claim 61, wherein a static concentrator overlays said bottom.

108. The solar cell arrangement of claim 107, wherein said static concentrator is a compound parabolic concentrator.

109. The solar cell arrangement of claim 107, wherein said static concentrator is a v-groove reflector.
